(19) United States
(12) Patent Application Publication
(10) Pub. No.: US 2005/0065538 A1
(43) Pub. Date: Mar. 24, 2005

(54) Asymmetric shaver and methods for making same

(76) Inventor: Robert Allen Van Wyk, Largo, FL (US)

Correspondence Address: ROBERT A. VAN WYK, 10801 STARKEY RD. #104-16, LARGO, FL, 33777, US

(21) Appl. No.: 10/937,210

(22) Filed: Sep. 9, 2004

Related U.S. Application Data
(60) Provisional application No. 60/504,618, filed on Sep. 22, 2003.

(51) Int. Cl. B23D 63/12

(52) U.S. Cl. 606/159

(57) ABSTRACT

A surgical shaver blade is provided with a stationary elongated outer tube, having a cutting window at its distal tip and a rotatable elongated inner tube having a cutting window at its distal tip. Each cutting window is not symmetrical about any line in a sectional view through the window normal to the tube axis. In a preferred embodiment the cutting edges of each window have a plurality of teeth, the teeth of one lateral cutting edge being offset axially from the teeth of the other lateral edge so that the teeth of one edge align axially with the valleys between teeth on the opposite edge. When the shaver is used in oscillate mode, the teeth of one direction of rotation align with tissue that was between teeth during the previous opposite direction rotation thereby enhancing the ability of the teeth to penetrate the tissue and prevent its ejection from the cutting window as the cutting edges approach. In another embodiment the outer window is asymmetric without teeth and the inner window is asymmetric with teeth. In yet another embodiment only the inner cutting edges are asymmetric. The cutting edges are formed in a single grinding operation or multiple grinding operations using a multi-axis CNC grinding machine, or electrochemically.

### PRIORITY

This application claims the benefit of provisional application 60/504,618 filed Sep. 22, 2003.

### BACKGROUND OF THE INVENTION

The invention relates to elongated, powered surgical instruments for use in endoscopic tissue resection. More particularly, the invention relates to an instrument having an elongated inner tube rotatably situated within an elongated stationary outer tube, both inner and outer tubes having, at their distal ends, cutting apertures which cooperate to resect tissue during endoscopic surgical procedures. Still more particularly, the invention relates to methods for forming cutting aperatures in the distal ends of these endoscopic surgical devices.

The use of elongated surgical cutting instruments has become well accepted in performing closed surgery such as arthroscopic or, more generally, endoscopic surgery. In closed surgery, access to the surgical site is gained via one or more portals, and instruments used in the surgical procedure must be elongated to permit the distal ends of the instruments to reach the surgical site. Surgical cutting instruments for use in closed surgery—also known as “shavers”—have an elongated outer tubular member terminating at a distal end having an opening in the end or side wall (or both) to form a cutting window and an elongated inner tubular member concentrically disposed in the outer tubular member and having a distal end disposed adjacent the opening in the distal end of the outer tubular member. The distal end of the inner tubular member has a surface or edge for engaging tissue via the opening in the outer tubular member and cooperates with the opening to shear, cut or trim tissue. The inner tubular member is rotatably driven about its axis from its proximal end by a handpiece having a small electric motor which is controlled by finger actuated switches on the handpiece, a foot switch or switches on a console supplying power to the handpiece. The distal end of the inner tubular member can have various configurations depending upon the surgical procedure to be performed, and the opening in the distal end of the outer tubular member has a configuration to cooperate with the particular configuration of the distal end of the inner tubular member. For example, the inner and outer tubular members can be configured to produce side cutting or end cutting, or a combination of the two; of soft or bony tissues or combinations of the two. These various configurations are referred to generically as shaver blades. Cut tissue is aspirated through the hollow lumen of the inner tubular member to be collected via a vacuum tube communicating with the handpiece.

Resection of tissue by a shaver blade is accomplished by cooperative interaction between the edges of the inner and outer cutting windows. As the inner and outer windows come into alignment, vacuum within the lumen of the inner tube sucks tissue into the opening formed. Continued rotation of the inner member causes the inner cutting edges to approach the outer cutting edges. Tissue in the cutting window between the inner and outer edges is either trapped between the edges or ejected from the window. Tissue trapped between the edges is either cut by the edges as they approach each other or torn by the cutting edges as they pass and rotate away from each other. The resected tissue is aspirated from the site through the inner lumen of the inner tube.

Resection efficiency is improved by decreasing the relative portion of the material that is ejected from the window, and increasing the portion that is trapped between the edges and resected. Decreasing the relative portion ejected from the window is accomplished by increasing the cutting edge sharpness. Increasing the sharpness is accomplished by decreasing the included angle of the cutting edge, by decreasing the edge radius, and by decreasing the roughness of the surfaces over which tissue must slide during resection. U.S. Pat. No. 5,843,106 by Heisler teaches a shaver with increased resection efficiency produced by an outer cutting window configuration having “sharpened” low included-angle cutting edges. The relative portion of tissue ejected from the window during closure may also be decreased by adding teeth to either the inner cutting edges or outer cutting edges or both. Shavers having inner cutting edges with teeth are well known in the art. U.S. Pat. No. 5,217,479 by Shuler and U.S. Pat. No. 5,269,798 by Winkler teach shavers having inner cutting edges with teeth, the teeth being formed by a “through-cutting” process such as wire electrical discharge machining (wire EDM) or by grinding. The teeth so formed are efficient at retaining tissue within the window so that it can be cut by the low included angle outer cutting edges as the inner and outer edges converge. The inner cutting edges do little cutting since the teeth form a very large included angle cutting edge. The Cuda™ by Linvatec Corporation (Largo, Fla.) and the Tomcat™ by Stryker Corporation (Kalamazoo, Mich.) have teeth on both the inner and outer cutting edges, the edges being formed by a two-dimensional, through-cutting process such as grinding or wire EDM. The edges formed have large included angles, geometry inefficient for cutting tissue. Shavers having these two-dimensionally shaped teeth on the inner and outer cutting edges separate tissue principally by tearing as the edges pass each other during closing of the cutting window. Such tearing is undesirable since the torn tissue may frequently become wrapped into the gap between the inner and outer tubes and cause clogging. Van Wyk, et al, in U.S. Pat. No. 6,053,928 teach a shaver having a plurality of teeth on the laterally opposed cutting edges of an outer window, the cutting edges being symmetrical when viewed in a plane normal to the axis of the tube. The cutting edges are formed so that, when viewed in any such plane, the edges have low included angles, in the valleys between the teeth as well as the teeth. The Great White™ shaver by Linvatec, constructed in accordance with the principles of this patent, is very efficient at resecting tissue and experiences reduced clogging due to the sharpness of the outer cutting edges.

When a shaver is used with a constant rotation imparted to the inner tube, tissue in close proximity to the window is sucked into the window and either resected or ejected from the window in the manner previously herein described. Tissue which is ejected from the window, or the remaining tissue adjacent to a resected portion is swept in the direction of the rotation. When the cutting window is opened again by the rotation of the inner member, the amount of tissue which will be pulled into the window by vacuum in the inner lumen is diminished from that of the previous opening event because of this directional “set” of the tissue. That is, because the tissue is already preferentially oriented in the direction of the rotation of the approaching inner cutting edge, it is difficult for that inner cutting edge to get sufficient “bite” to retain the tissue in the cutting window for resection. Because of this, arthroscopic shavers are generally used in an “oscillate” mode when cutting tissue. In this mode the inner is rotated in one direction for a predetermined number of revolutions, whereupon its rotation is reversed for the same predetermined number of revolutions. The inner cutting edges approach the tissue from alternating directions thereby greatly increasing the relative portion of tissue that is sucked into the window and is resected rather than ejected.

Further improvement in efficiency is, however, possible. When an inner cutting edge with teeth intersects tissue it removes tissue preferentially in the vicinity of the teeth. Even if the inner is operated in oscillate mode, because the teeth are symmetrically aligned about the centerline of the window, the regions of preferential tissue removal are also aligned. The amount of tissue which a tooth is able to entrap between the cutting edges is reduced since the tooth is attempting to entrap tissue in a region in which tissue was removed by the laterally opposed tooth in its previous closure of the oscillation cycle. This is particularly true in the resection of tough tissues such as meniscus or spinal disc where the resection efficiency is heavily dependent on the ability of teeth to grab and retain tissue.

It is, accordingly, an object of this invention to produce a shaver blade with high resection efficiency due to advanced cutting edge geometry.

It is also an object of this invention to produce a shaver blade with high resection efficiency due to advanced cutting edge geometry wherein the teeth of the inner cutting edges or outer cutting edges or both are not symmetrically positioned about the cutting window center plane.

It is also an object of this invention to produce a method for forming the cutting edges of a shaver blade with high resection efficiency due to advanced cutting edge geometry in which the teeth on the cutting edges are asymmetrically positioned about the window center plane.

### SUMMARY OF THE INVENTION

These and other objects are accomplished in the invention herein disclosed which is a shaver blade having inner cutting edges or outer cutting edges or both, which are not symmetrical when sectioned and viewed in a plane normal to the tube axis. In one embodiment teeth on the inner and outer cutting edges are produced by a two-dimensional, linear grinding process in which the axes of the shaver inner and outer tubes are angled with respect to the grinding wheel axis so that the teeth on one side of a resulting cutting window are aligned with the valleys between the teeth on the opposite side of that window. The teeth on a given side of the inner and outer cutting windows are in approximate alignment axially so that, when the inner is rotated within the outer, the teeth on one side of the inner approximately align with the troughs between the teeth of the opposing outer edge during entrapment of tissue between the edges. Both cutting edges in this embodiment have large included angles. In another embodiment the teeth are similarly positioned, however, the outer teeth have a complex shape with low included angle cutting edges throughout to improve resection efficiency, the outer being produced by an advanced electrochemical process. In yet another embodiment, also having asymmetrically positioned inner and outer teeth, and with low included angle outer cutting edges, the outer cutting edges are formed by a multi-step grinding process on a multiple-axis CNC grinding machine such as, for instance, a GrindSmart 620XS™ by Rollomatic USA (Mundelein, Ill.). The axis of the outer tube is angularly offset from that of a grinding wheel which has a peripheral edge formed to a shape suitable for producing the trough between adjacent teeth on a shaver outer cutting edge. The tube is positioned at a first position relative to the grinding wheel, the tube axis being offset a predetermined angle from the grinding wheel axis. A grinding operation is performed in which the tube is simultaneously advanced axially and rotated about an axis offset from the tube axis, relative to the rotating grinding wheel so as to form a first portion of a helical opening in a predetermined distal portion of the outer tube, the helix axis being offset from the tube axis. The tube is then repositioned to a second position. The grinding operation is performed at the second location so as to form a second portion of a helical opening adjacent to the first portion, the juncture between the first helical portion and second portion forming a protrusion, or tooth on each lateral side of the opening. Through a sequence of repositioning and grinding operations, outer cutting edges are formed, the cutting edges having a plurality of protrusions (teeth) separated by troughs, the protrusions of one edge being approximately laterally opposed to the troughs of the opposite edge. The cutting edges so formed have troughs formed with an oblique surface which decreases the included angle of the cutting edge.

In certain applications, for instance when cutting tough tissue such as meniscus, it is advantageous to have fewer but larger teeth on the inner cutting edges than on the outer cutting edges. Accordingly, in another embodiment the number of teeth on the inner and outer cutting edges is not equal. In yet other embodiments the number of teeth on one lateral cutting edge is not equal to the number of teeth on the other lateral cutting edge.

In yet another embodiment the outer cutting edges are asymmetrical but do not have teeth, the cutting window being formed in a single grinding operation. It is not always desirable to have outer cutting edges with teeth. When cleaning tissue from bony surfaces, or when resecting bone, the teeth of the outer cutting edge may be deformed by impact with the bone. Some surgeons also prefer an outer window without teeth since teeth on the outer cutting edges may cause inadvertent damage to articulator surfaces when the shaver is inserted into the joint space. An outer window with asymmetrical cutting edges has increased resection efficiency compared to a conventional window due to the different “scissoring” action of each edge when the shaver is used in oscillate mode. To form the outer cutting edges of this embodiment, the periphery of a grinding wheel is formed to a shape suitable for grinding the outer cutting window of a shaver. The tube is positioned at a first position relative to the grinding wheel, the tube axis being offset from the grinding wheel axis a predetermined angle. A grinding operation is performed in which the tube is simultaneously advanced axially and rotated about an axis offset from the tube axis, relative to the rotating grinding wheel so as to form a helical opening in a distal portion of the outer tube, the helix axis being offset from the tube axis. The opening so formed has edges which are not symmetrical when viewed in a section normal to the axis of the tube and which are surrounded by an oblique surface extending outwardly from the perimeter of the opening at the tube inner surface to the outer surface of the tube. The form of this oblique surface decreases the included angle of the cutting edge, in effect “sharpening” the edge.

All of the embodiments herein described achieve increased resection efficiency through the use of advanced cutting edge configurations. Specifically, increased efficiency is achieved through asymmetric cutting edges which reduce the portion of tissue which is ejected from the cutting window during window closure when a shaver is used in oscillate mode. Preferred methods for producing the windows are grinding or electrochemical methods, although electrical discharge machining (EDM) may be used.

### BRIEF DESCRIPTION OF THE DRAWINGS

FIG. 1 is a disassembled view of an arthroscopic shaver blade.

FIG. 2 is a plan view of the distal portion of a prior art shaver blade

FIG. 3 is a side elevational view of the object of FIG. 2.

FIG. 4 is a distal end view of the object of FIG. 2.

FIG. 5 is a perspective view of the object of FIG. 2.

FIG. 6 is a plan view of the distal portion of an arthroscopic shaver constructed in accordance with the principles of this invention.

FIG. 7 is a side elevational view of the object of FIG. 6.

FIG. 8 is a distal end view of the object of FIG. 6.

FIG. 9 is a perspective view of the object of FIG. 6.

FIG. 10 is a plan view of the outer cutting window of the object of FIG. 6.

FIG. 11 is a side elevational view of the object of FIG. 10.

FIG. 12 is a distal end view of the object of FIG. 10.

FIG. 13 is a perspective view of the object of FIG. 10.

FIG. 14 is an elevational view of the object of FIG. 10 in direction 108 of FIG. 10.

FIG. 15 is a plan view of the inner cutting window of the object of FIG. 6.

FIG. 16 is a side elevational view of the object of FIG. 15.

FIG. 17 is a distal end view of the object of FIG. 15.

FIG. 18 is a perspective view of the object of FIG. 15.

FIG. 19 is an elevational view of the object of FIG. 15 in direction 78 of FIG. 15.

FIG. 20 is an expanded axial sectional view of the object of FIG. 2 at location 110.

FIG. 21 is an expanded axial sectional view of the object of FIG. 6 at location 112.

FIG. 22 is a plan view of an alternate embodiment.

FIG. 23 is a side elevational view of the object of FIG. 22.

FIG. 24 is an axial end view of the object of FIG. 22.

FIG. 25 is a perspective view of the object of FIG. 22.

FIG. 26 is a plan view of the outer cutting window of the object of FIG. 22.

FIG. 27 is a side elevational view of the object of FIG. 26.

FIG. 28 is an axial end view of the object of FIG. 26.

FIG. 29 is a perspective view of the object of FIG. 26.

FIG. 30 is an expanded axial sectional view of the object of FIG. 26 at location 160.

FIG. 31 is a plan view of the distal end of an alternate embodiment

FIG. 32 is a side elevational view of the object of FIG. 31.

FIG. 33 is a distal axial view of the object of FIG. 31.

FIG. 34 is a perspective view of the object of FIG. 31.

FIG. 35 is plan view of the outer tube of the embodiment of FIG. 31.

FIG. 36 is a side elevational view of the object of FIG. 35.

FIG. 37 is a distal axial view of the object of FIG. 35.

FIG. 38 is a perspective view of the object of FIG. 35.

FIG. 39 is an expanded axial sectional view of the object of FIG. 31 at location 201

FIG. 40 is a radial edge view of a grinding wheel used to make the outer cutting window of the object of FIG. 35.

FIG. 41 is an axial view of the object of FIG. 40.

FIG. 42 is an expanded tangential view of the edge of the object of FIG. 40.

FIG. 43 is a plan view of an outer tube and grinding wheel arrangement for producing the outer cutting window of the object of FIG. 35.

FIG. 44 is a side elevational view of the objects of FIG. 43.

FIG. 45 is a view of the objects of FIG. 43 viewed axially to the shaver outer tube distal end.

FIG. 46 is an expanded axial view of the objects of FIG. 43 in the region of the tube distal end.

FIG. 47 is an expanded side elevational view of the objects of FIG. 43 in the region of the tube distal end.

FIG. 48 is a plan view of the distal end of a shaver outer tube of the embodiment shown in FIG. 35 after completion of the first grinding operation.

FIG. 49 is a side elevational view of the object of FIG. 48.

FIG. 50 is a distal end view of the object of FIG. 48.

FIG. 51 is a perspective view of the object of FIG. 48.

FIG. 52 is a plan view of the distal end of a shaver outer tube of FIG. 35 after completion of the second grinding operation.

FIG. 53 is a side elevational view of the object of FIG. 52.

FIG. 54 is a distal end view of the object of FIG. 52.

FIG. 55 is a perspective view of the object of FIG. 52.

FIG. 56 is a plan view of the distal end of a shaver outer tube of FIG. 35 after completion of the third grinding operation.

FIG. 57 is a side elevational view of the object of FIG. 56.

FIG. 58 is a distal end view of the object of FIG. 56.

FIG. 59 is a perspective view of the object of FIG. 56.

FIG. 60 is a plan view of the distal end of a shaver outer tube of FIG. 35 after completion of the fourth grinding operation.

FIG. 61 is a side elevational view of the object of FIG. 60.

FIG. 62 is a distal end view of the object of FIG. 60.

FIG. 63 is a perspective view of the object of FIG. 60.

FIG. 64 is a perspective view of an outer tube cutting window produced by electrochemical methods.

FIG. 65 is a plan view of a cathode for making the object of FIG. 64.

FIG. 66 is a front elevational view of the object of FIG. 64.

FIG. 67 is a bottom view of the object of FIG. 64.

FIG. 68 is a side elevational view of the object of FIG. 64.

FIG. 69 is a partial sectional view of a fixture for producing the object of FIG. 64.

FIG. 70 is a plan view of the inner cutting window of an alternate embodiment.

FIG. 71 is a side elevational view of the object of FIG. 70.

FIG. 72 is an axial end view of the object of FIG. 70.

FIG. 73 is a perspective view of the object of FIG. 70.

FIG. 74 is an expanded axial sectional view at location 500 of FIG. 70.

FIG. 75 is a plan view of the distal end cutting windows of an alternate embodiment shaver having an asymmetric outer without teeth, and an asymmetric inner

FIG. 76 is a side elevational view of the objects of FIG. 75.

FIG. 77 is a perspective view of the objects of FIG. 75.

FIG. 78 is an expanded view of the periphery of a grinding wheel used to produce the outer cutting window of the object of FIG. 75.

FIG. 79 is a plan view of the outer cutting window of the embodiment of FIG. 75.

FIG. 80 is a sectional view of the object of FIG. 79 along direction A-A.

FIG. 81 is a perspective view of the object of FIG. 79.

### DESCRIPTION OF THE EMBODIMENTS

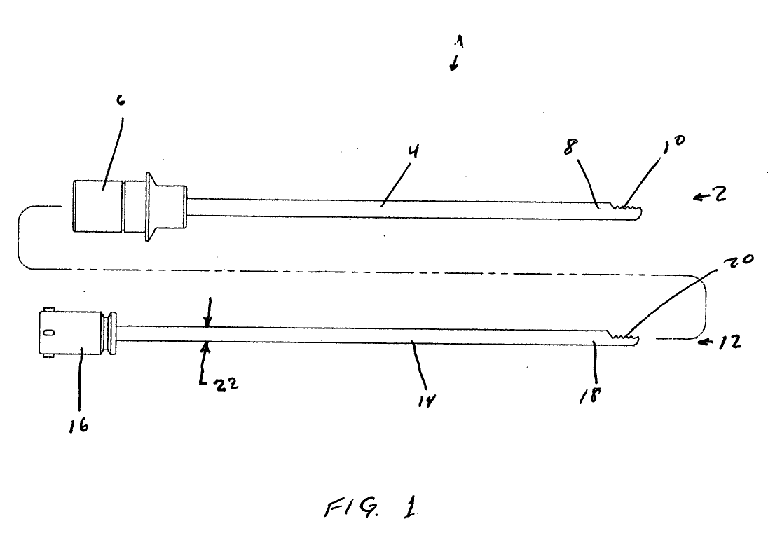

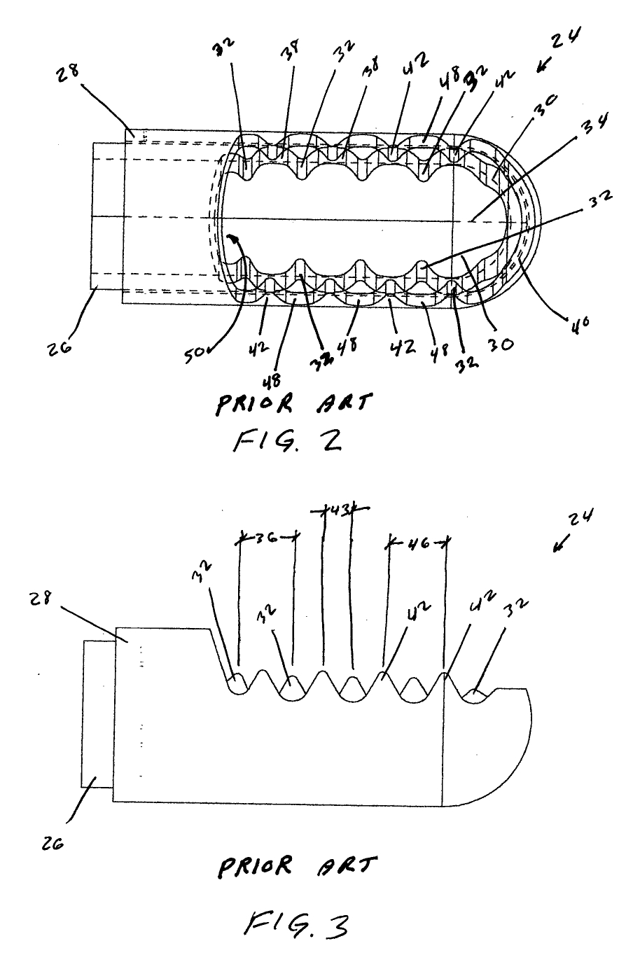

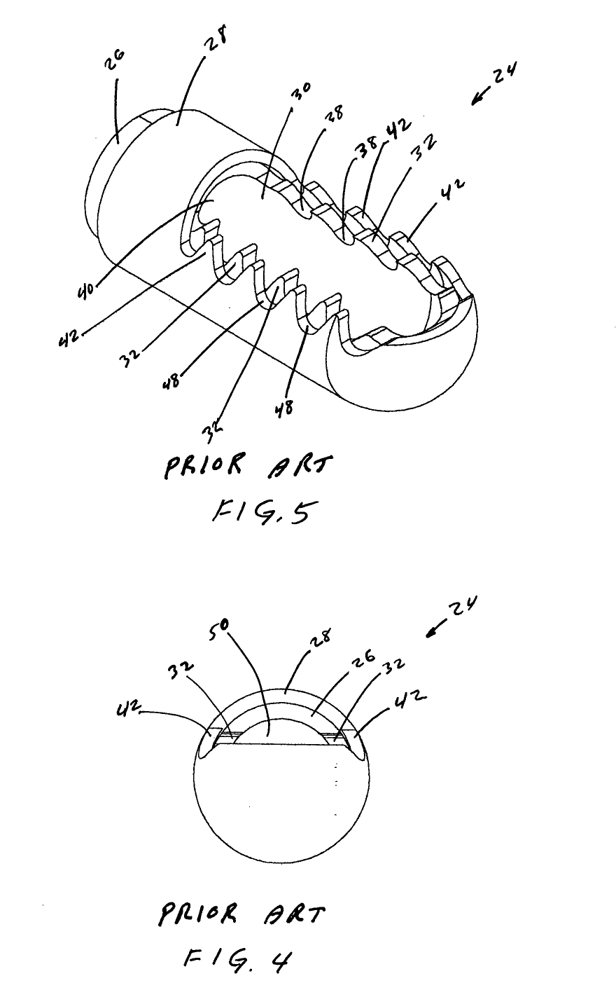

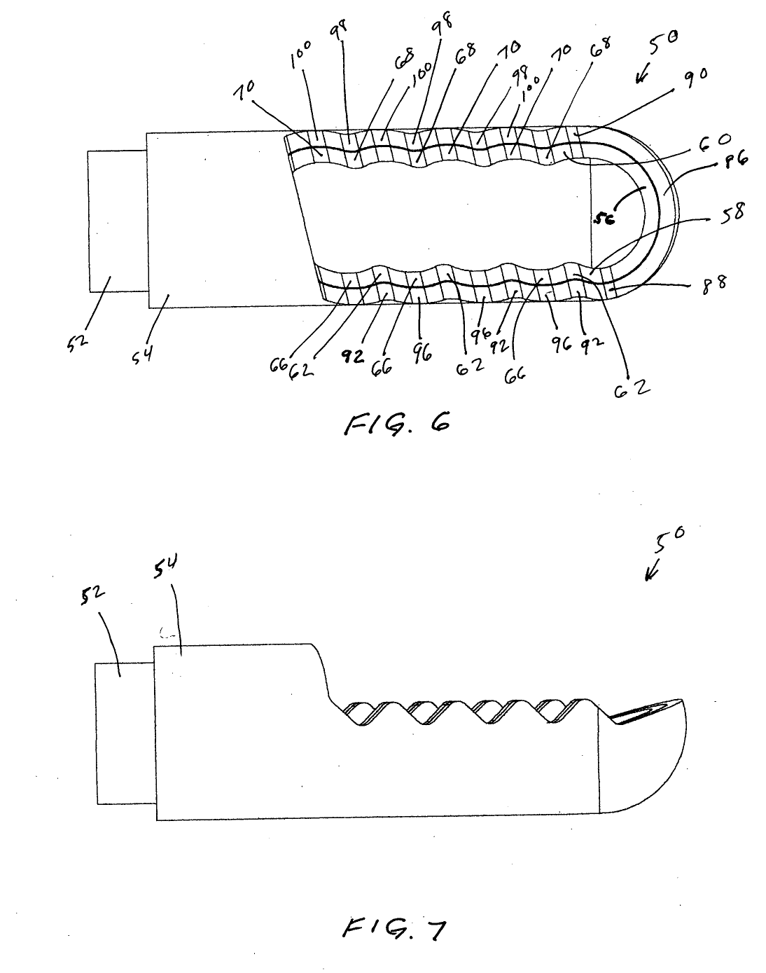

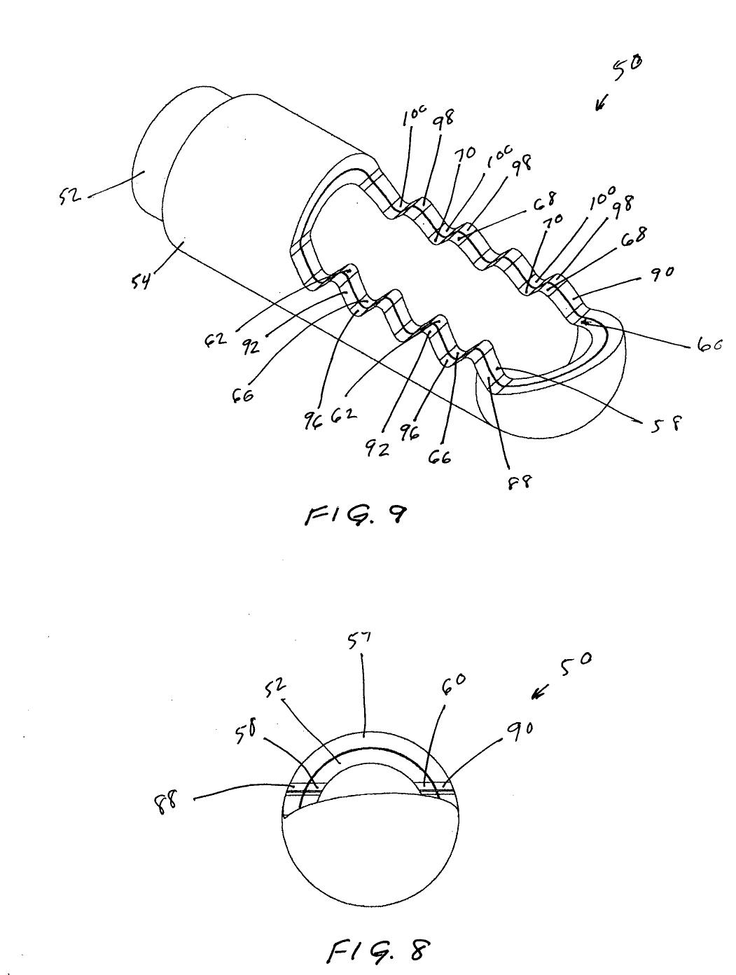

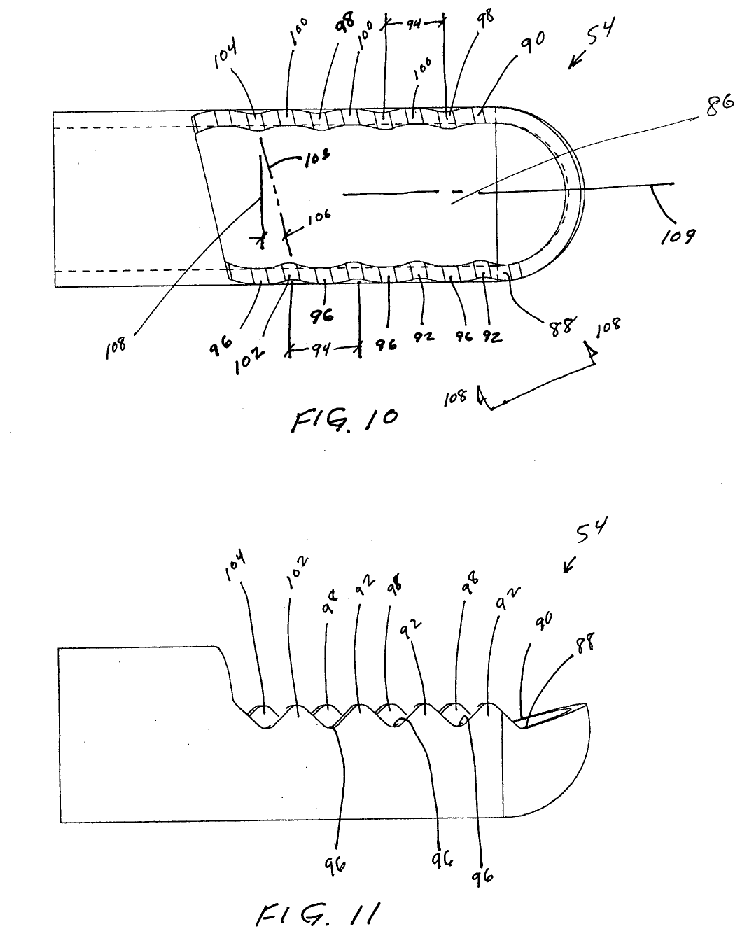

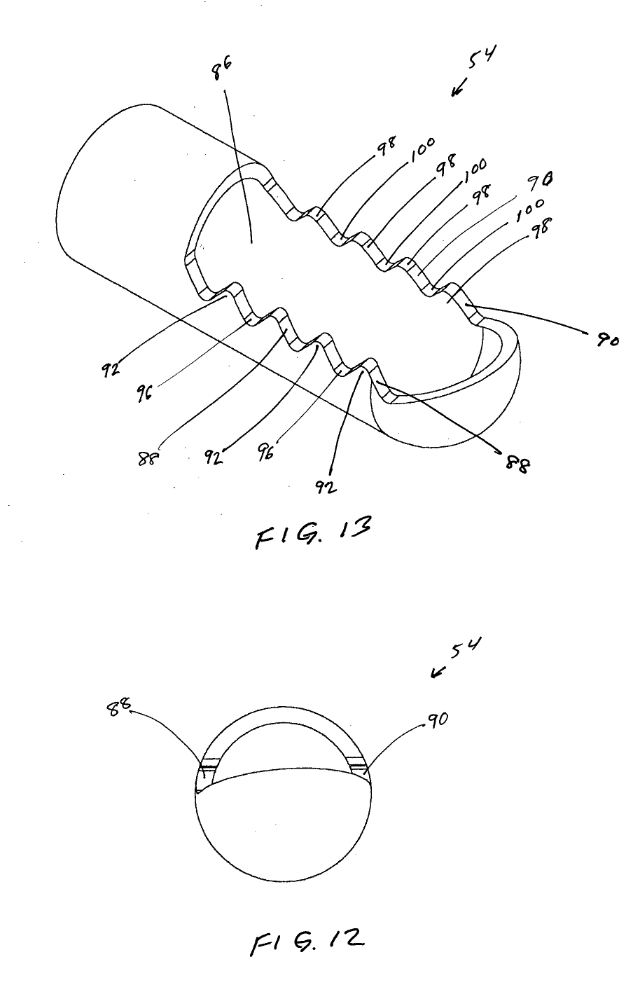

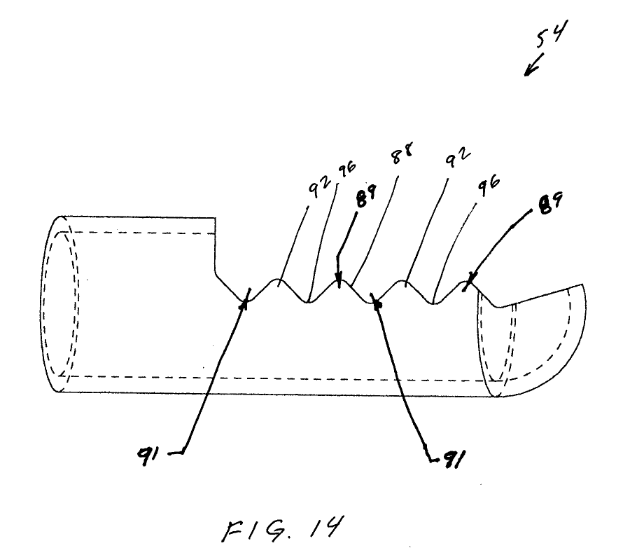

Referring first to FIG. 1, arthroscopic shaver 1 has an outer assembly 2 having a metallic, elongated, tubular distal portion 4 and a proximal portion 6 forming a hub suitable for mounting in a shaver handpiece. Distal portion 4 has a distal end 8 in which is formed cutting window 10. Shaver 1 also has an inner assembly 12 having an metallic, elongated, tubular distal portion 14 and a proximal portion 16 forming a hub suitable for transmitting rotational motion provided by a handpiece to inner assembly 12. Distal portion 14 has a distal end 18 in which is formed cutting window 20. Diameter 22 of distal portion 14 of inner assembly 12 is slightly less than the diameter of the inner lumen of distal portion 4 of outer assembly 2 so that inner assembly 12 may be rotatably positioned therein for use.

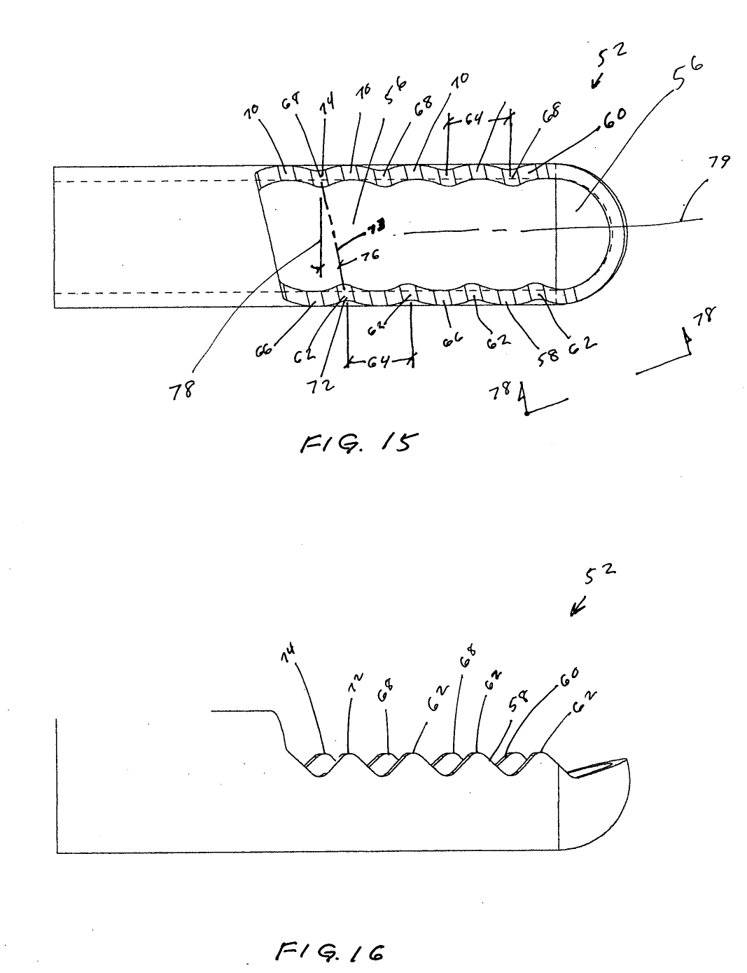

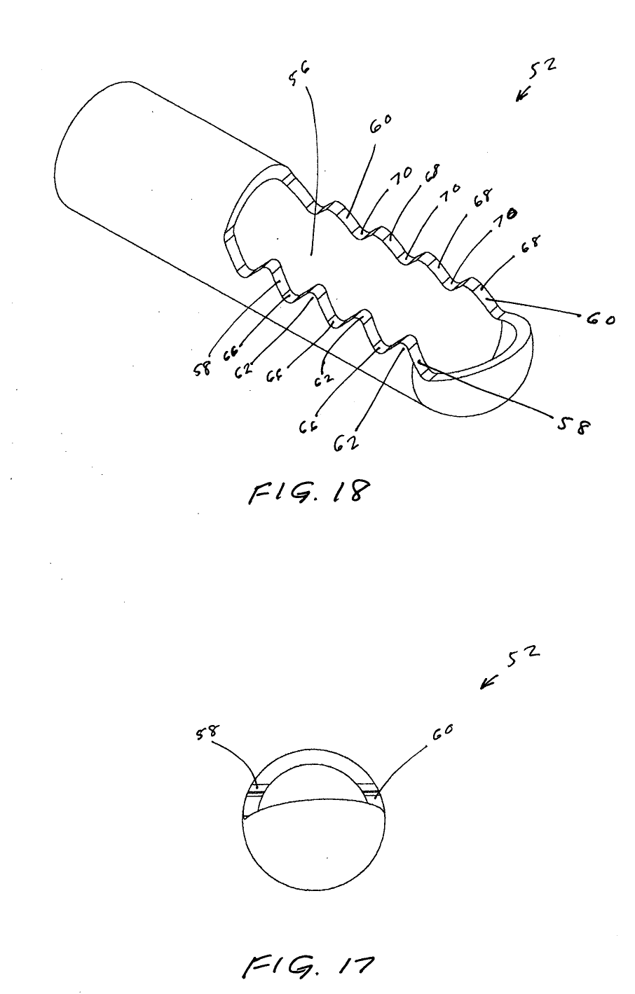

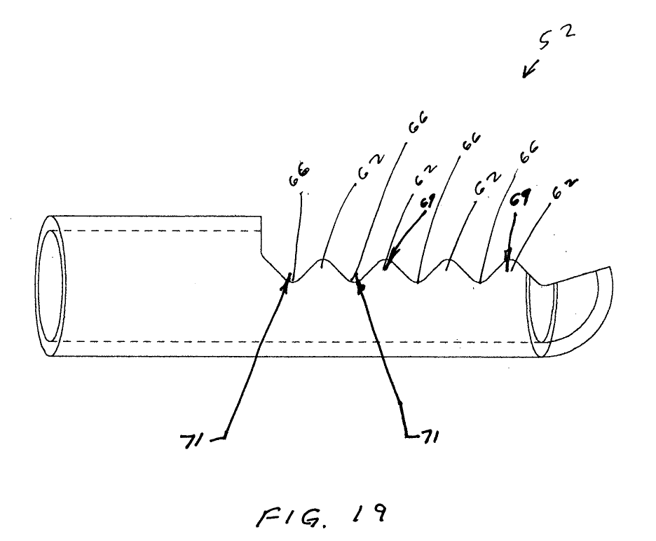

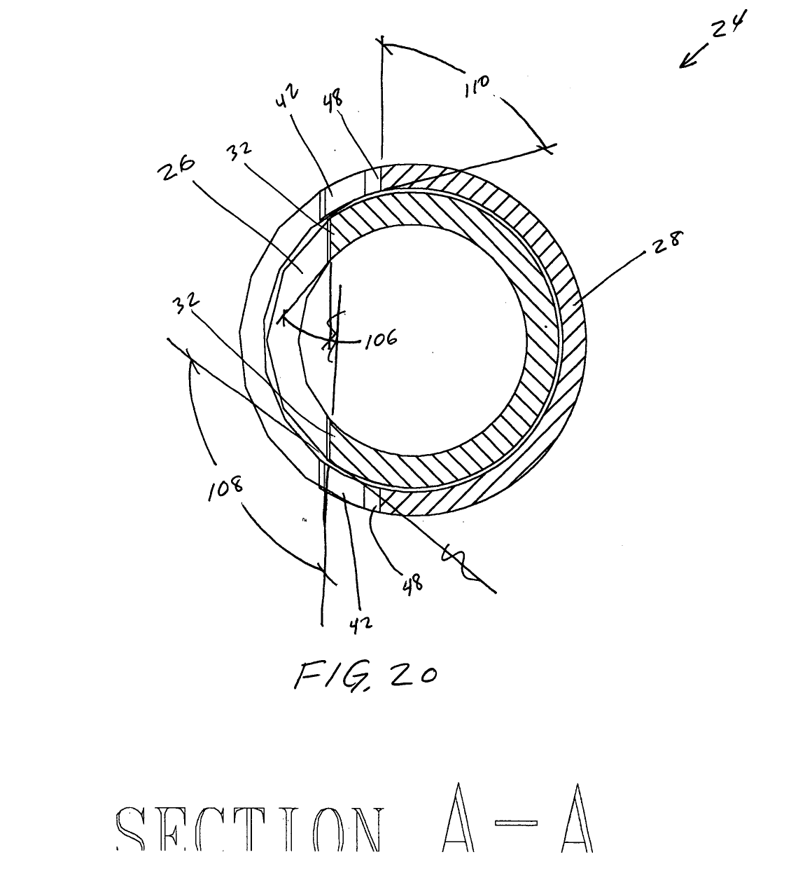

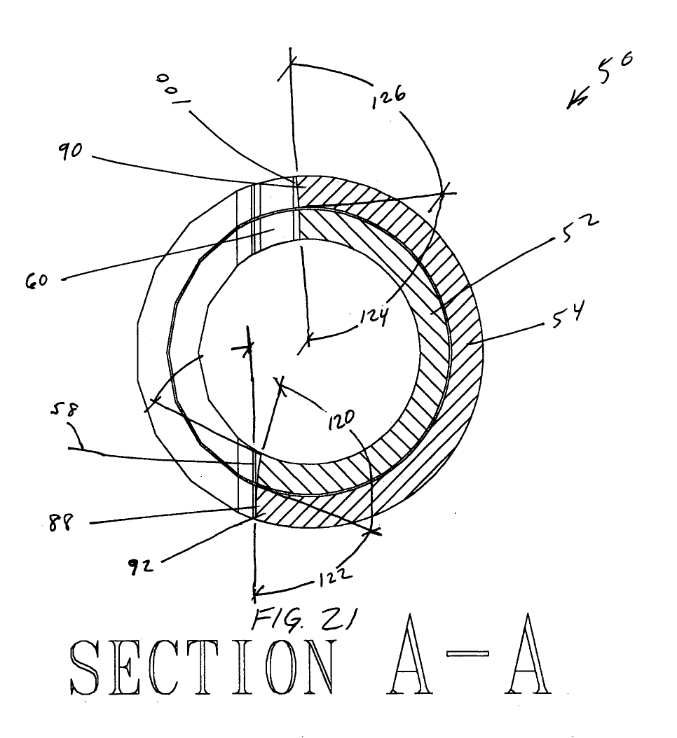

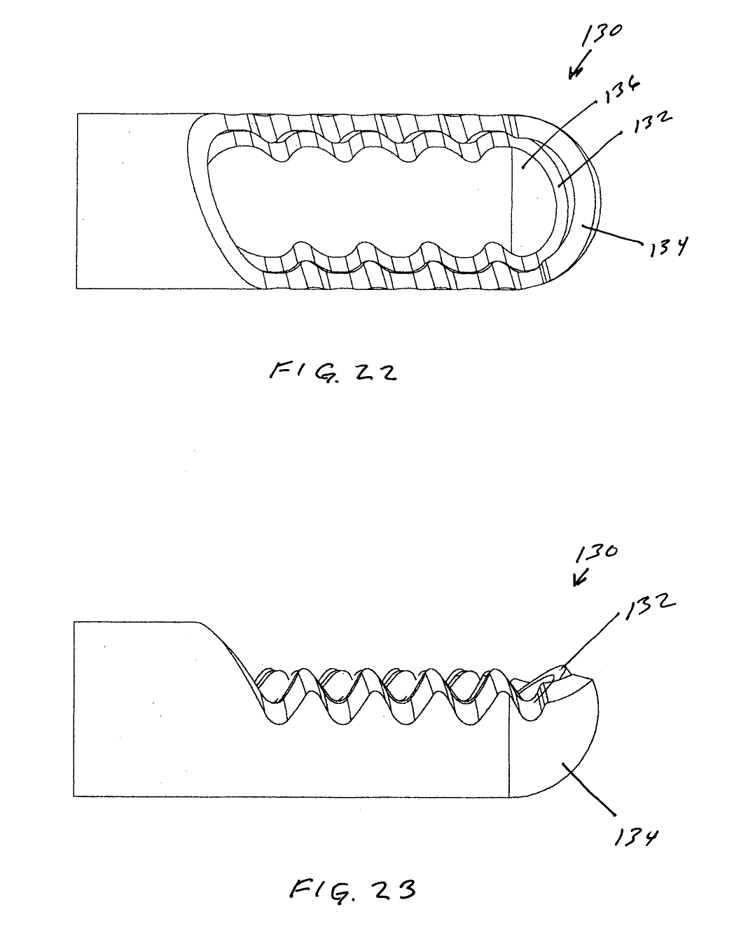

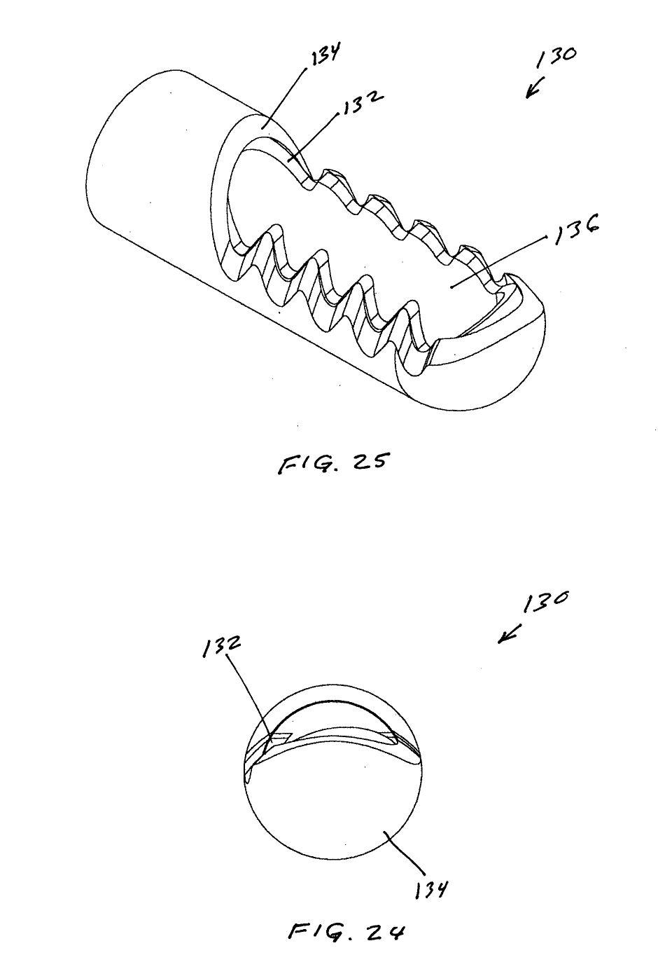

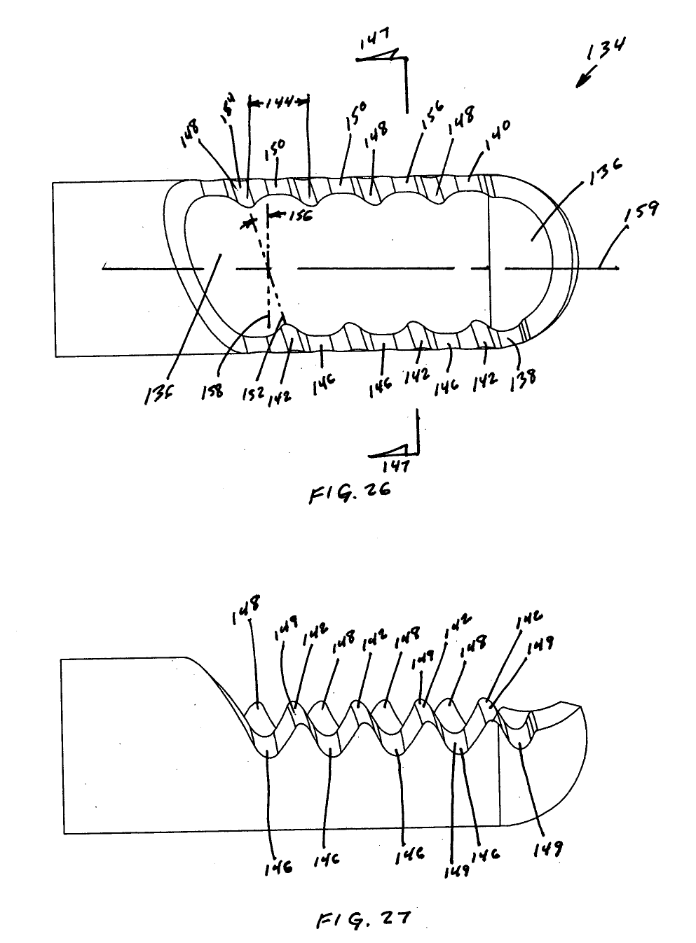

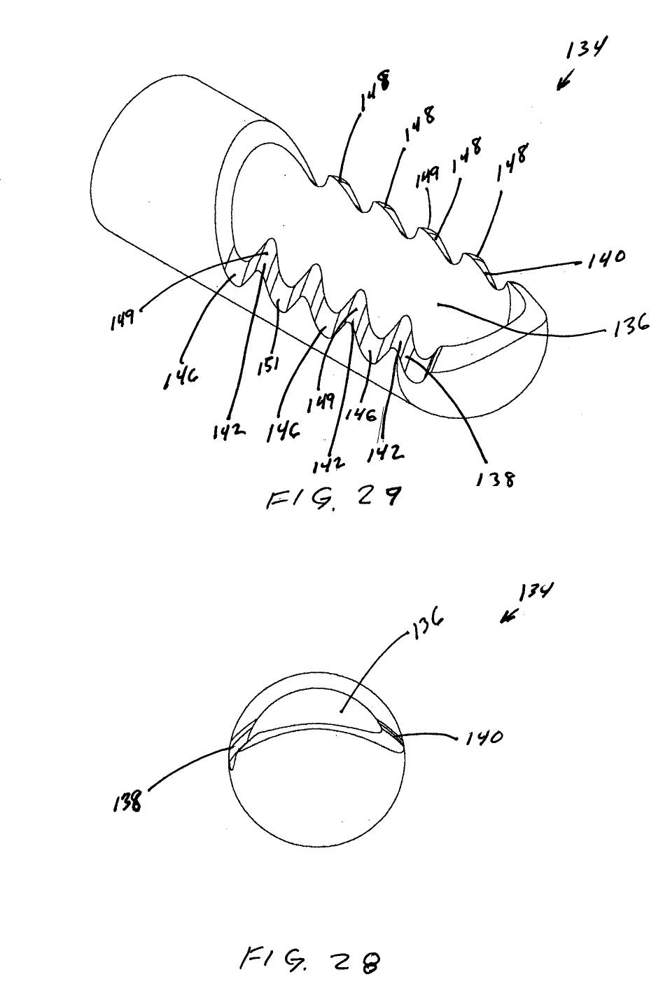

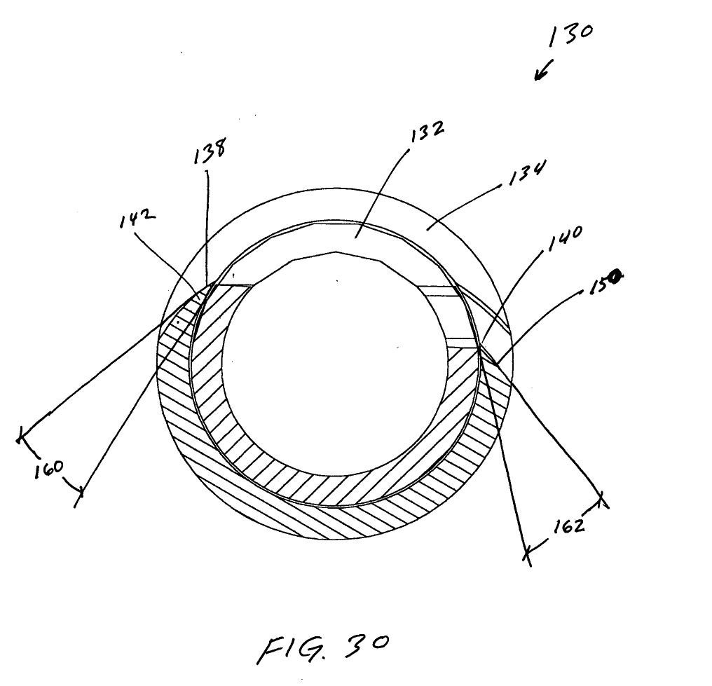

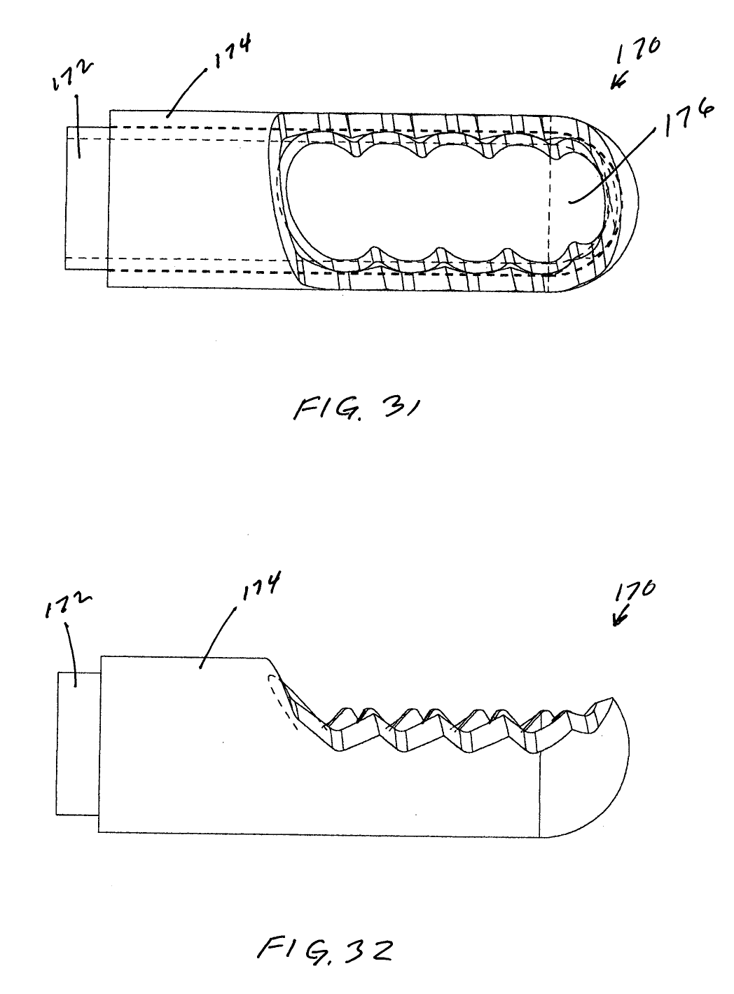

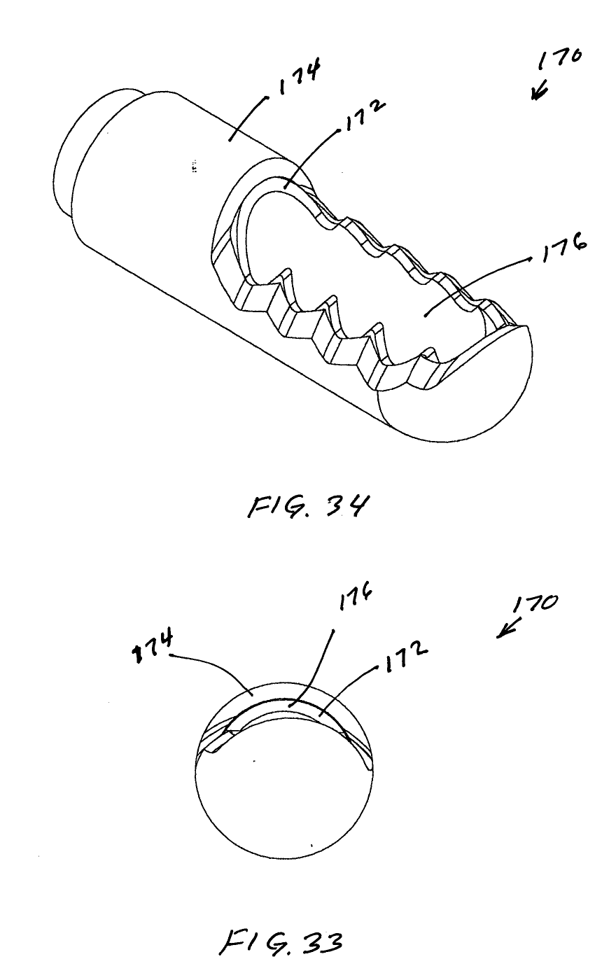

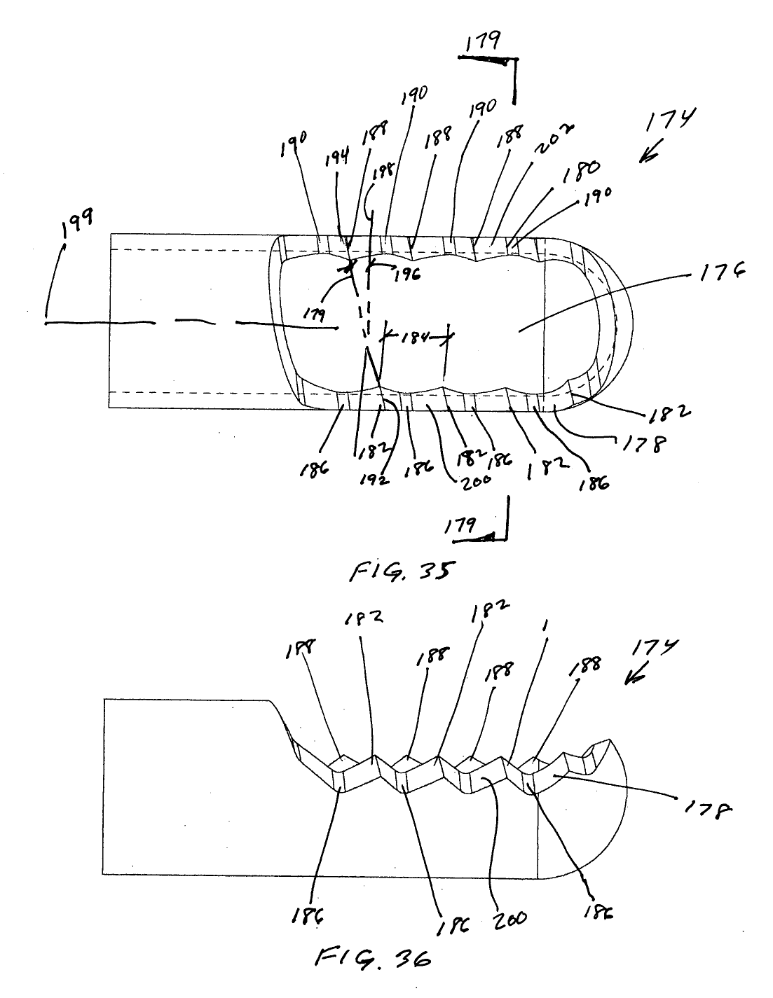

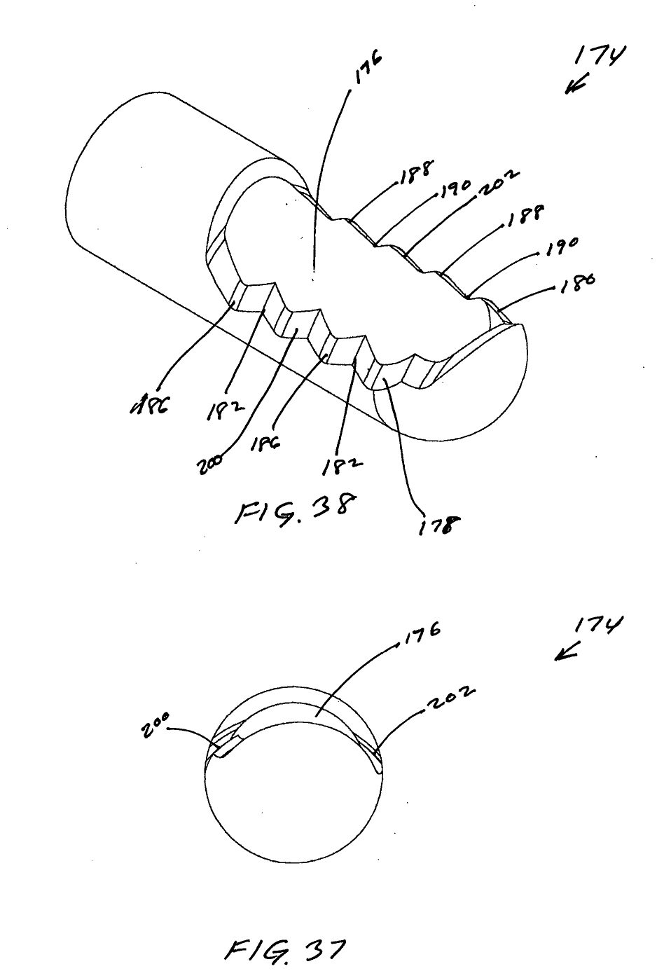

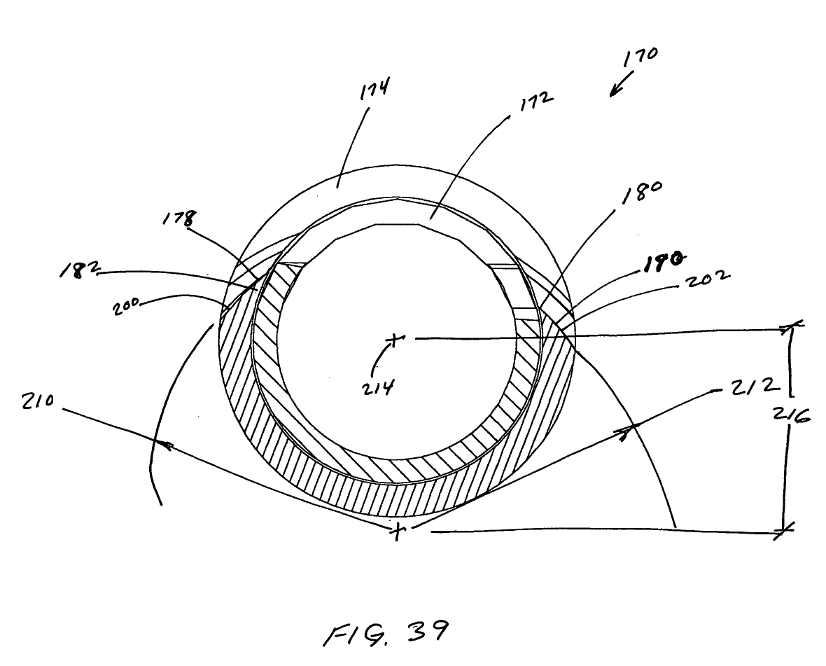

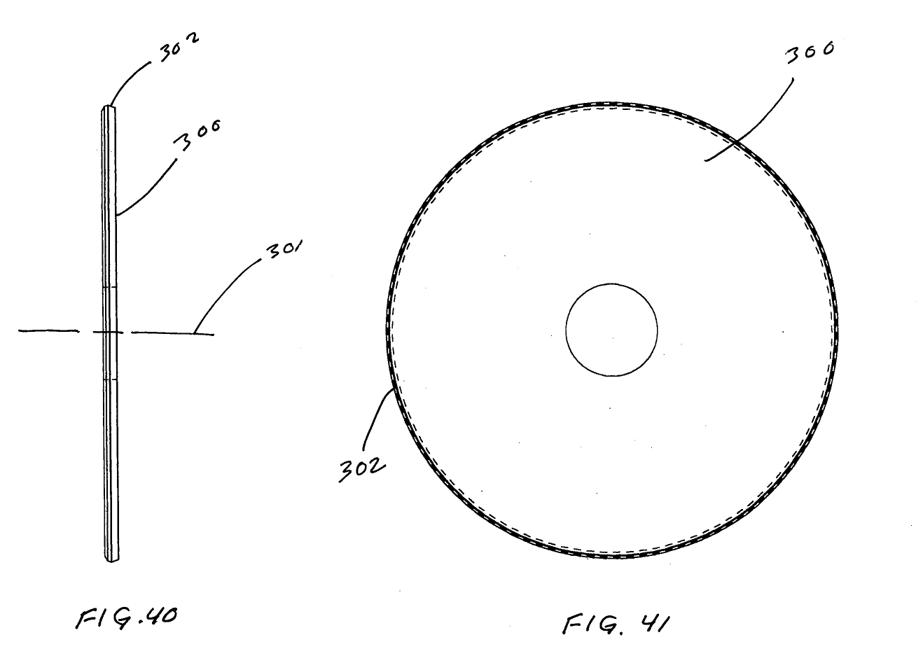

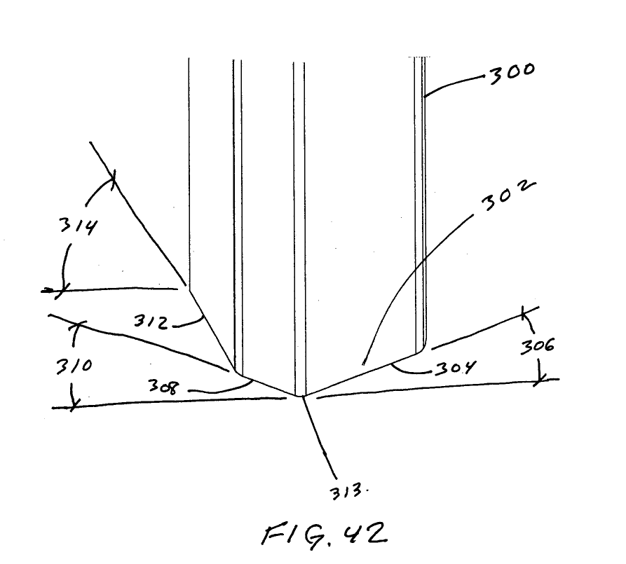

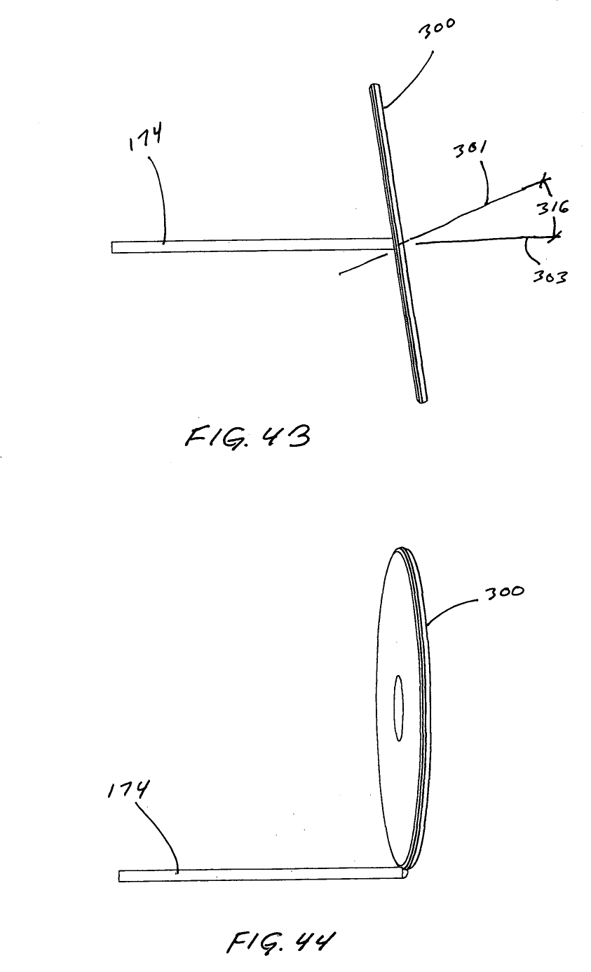

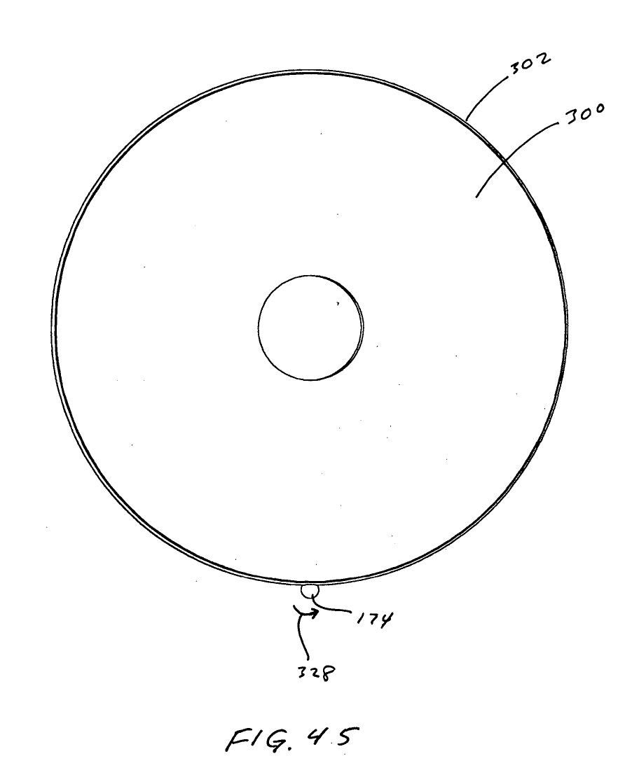

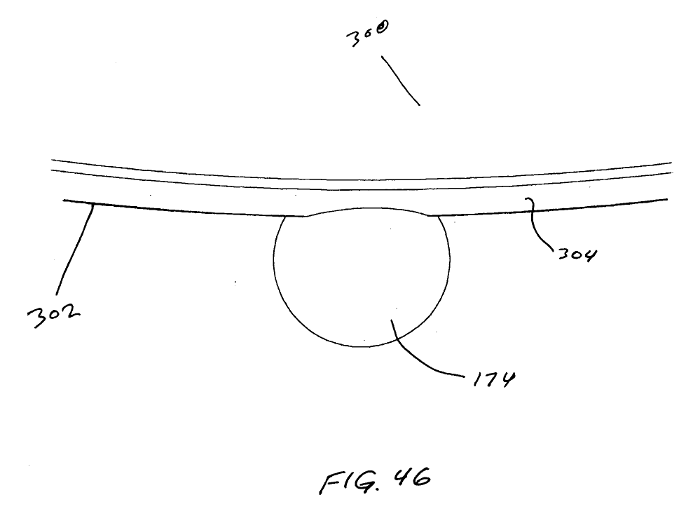

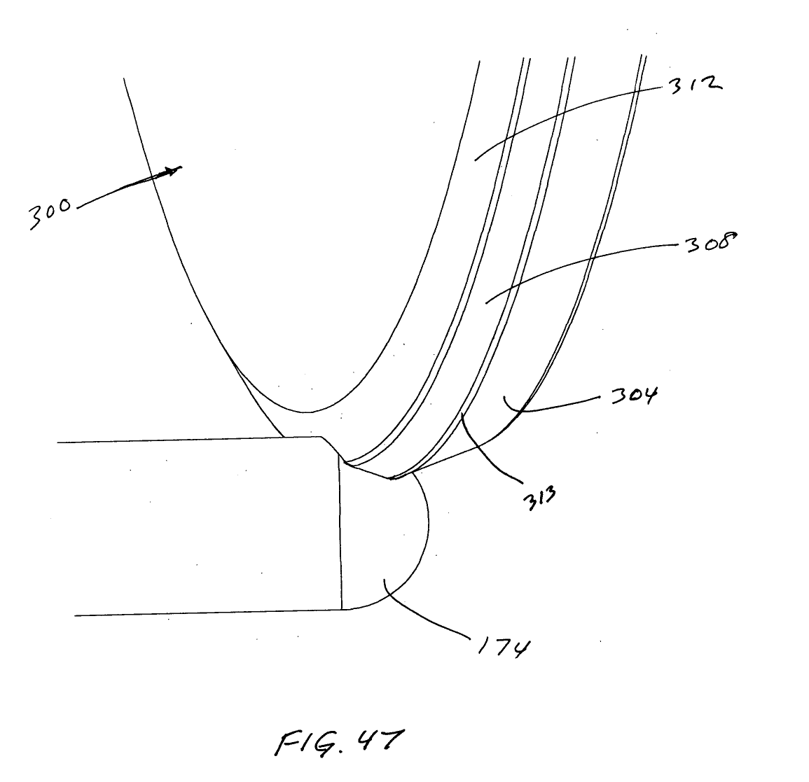

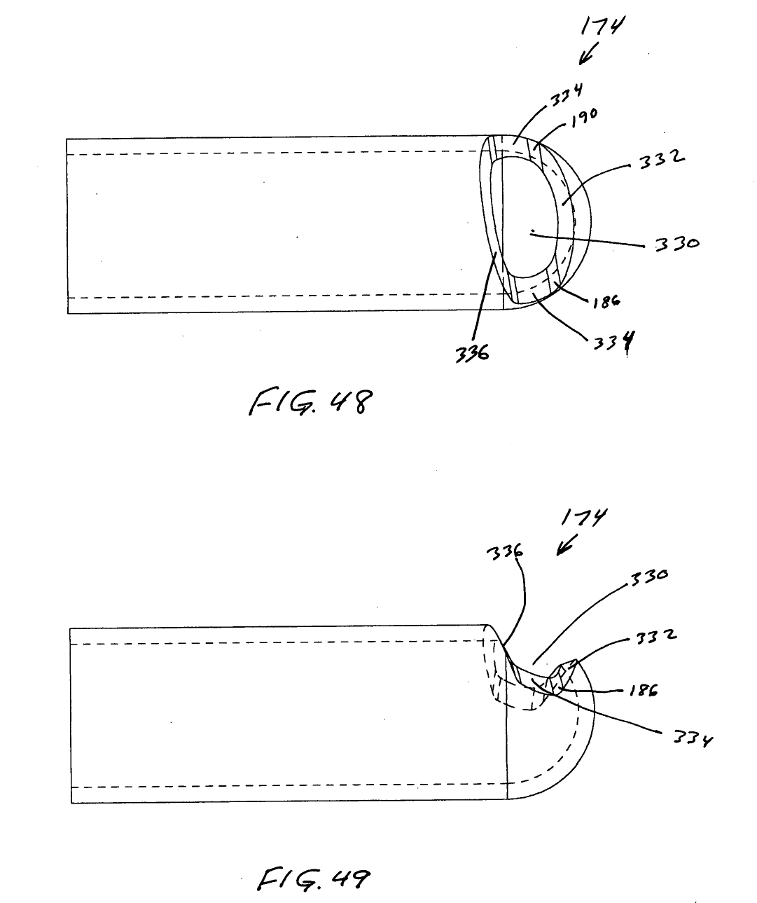

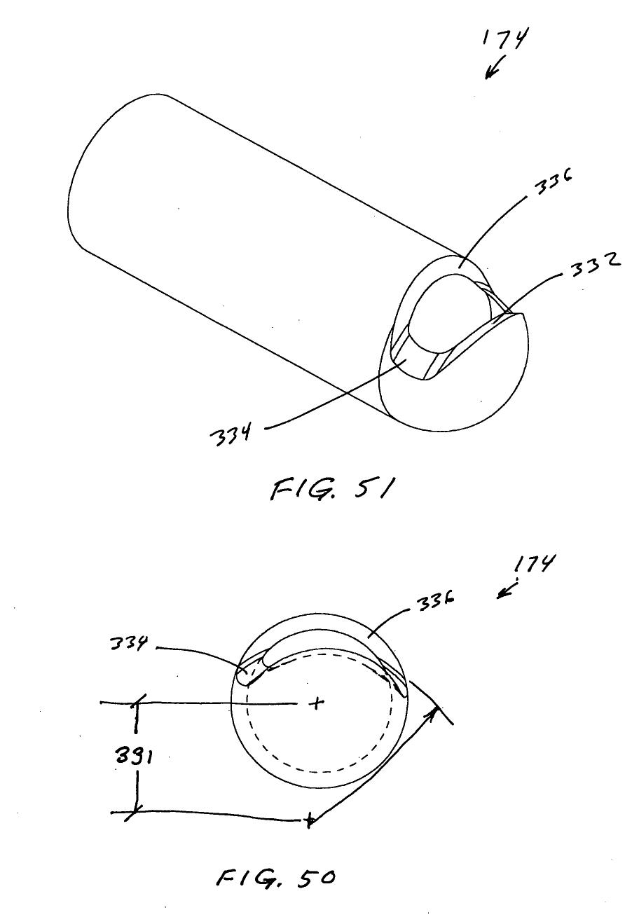

Referring to FIGS. 2 through 5 showing the distal end cutting windows of a prior art shaver 24, inner tube 26 is rotatably positioned within outer tube 28. Inner cutting window 30 has a plurality of teeth 32, which, as best seen in FIG. 2, are symmetrically placed about axis 34 when viewed in a plan view. Teeth 32 are spaced distance 36 apart and are separated by valleys 38. Outer cutting window 40 has a plurality of teeth 42, which, when viewed in the plan view seen in FIG. 2, are symmetrically placed about axis 34. Teeth 42 are spaced distance 46 apart, distance 46 being approximately equal to distance 36, and are separated by valleys 48. Inner window teeth 32 are displaced axially from outer window teeth 42 distance 43 equal to approximately half of distances 36 and 46 such that when the inner window is rotated toward the outer window, inner teeth 32 will line up with valleys 48 of outer window 40, and outer teeth 42 will line up with valleys 38 of inner cutting window 30. During use inner tube 26 is rotated within outer tube 28 in an oscillatory manner, that is, the inner tube is rotated in one direction a predetermined number of revolutions, stopped, and then rotated in the opposite direction a predetermined number of revolutions. This action is repeated as long as the handpiece in which the shaver is mounted is activated. Suction supplied to lumen 50 pulls tissue into contact with, and partially into, the opening formed by angular alignment of windows 30 and 40. As teeth 32 of inner cutting window 30 engage the tissue, some teeth may penetrate the tissue and drag a portion of the tissue toward teeth 42 of outer cutting window 40. Some of teeth 42 may also penetrate the tissue thereby ensuring that a portion of the tissue will be trapped between the closing window edges and resected. Portions of the tissue which are not penetrated by the teeth will likely be ejected from the closing window by the approaching cutting edges and will not be resected. The efficiency (aggressiveness) of a shaver is strongly affected by the ability of the inner cutting window edges to prevent tissue from being ejected from the closing aperture. This is strongly affected by the effectiveness of the teeth in penetrating a portion of the tissue which it encounters. When the rotation of the inner is reversed, the process is repeated, this time on the opposite side of the cutting windows. As in the previous rotation, the efficiency of the cutting action will be strongly affected by the ability of teeth 32 on inner window 30 to penetrate tissue in contact with, or partially drawn into, the cutting window. The regions of the tissue in contact with the teeth, however, are somewhat recessed because of the cutting action of the previous rotation, the teeth on each side of the cutting windows being symmetrically opposite each other. This is particularly true when cutting tough, resilient tissue such as, for instance, meniscus.

The cutting edges of prior art shaver 24 are formed by a through-cutting process such as wire EDM or grinding. Ground edges are made using a grinding wheel having a periphery in which grooves are formed, the grooves being configured such that when the wheel axis and tube axis are aligned parallel and the wheel is passed through a distal portion of the tube, cutting edges are formed, each groove forming a corresponding tooth on the cutting edges. Alternatively, ground cutting edges can be formed by a sequence of grinding operations using a grinding wheel having a periphery configured to form the valley between two adjacent teeth. The wheel is brought to a first position with its axis parallel to the tube axis, and in a grinding operation, the wheel passes through a portion of the distal end of the tube in a linear motion to a second position, the motion being perpendicular to the tube and grinding wheel axes. The grinding operation forms a first portion of the cutting window. The tube is repositioned axially and the positioning and grinding operations repeated so as to form a second portion of the cutting window adjacent to the first window portion, the adjacent first and second portions together forming a tooth on each of the lateral cutting edges. The sequence of positioning and grinding operations is repeated until the complete cutting window is formed, each subsequent grinding operation forming a tooth on each of the lateral cutting edges.

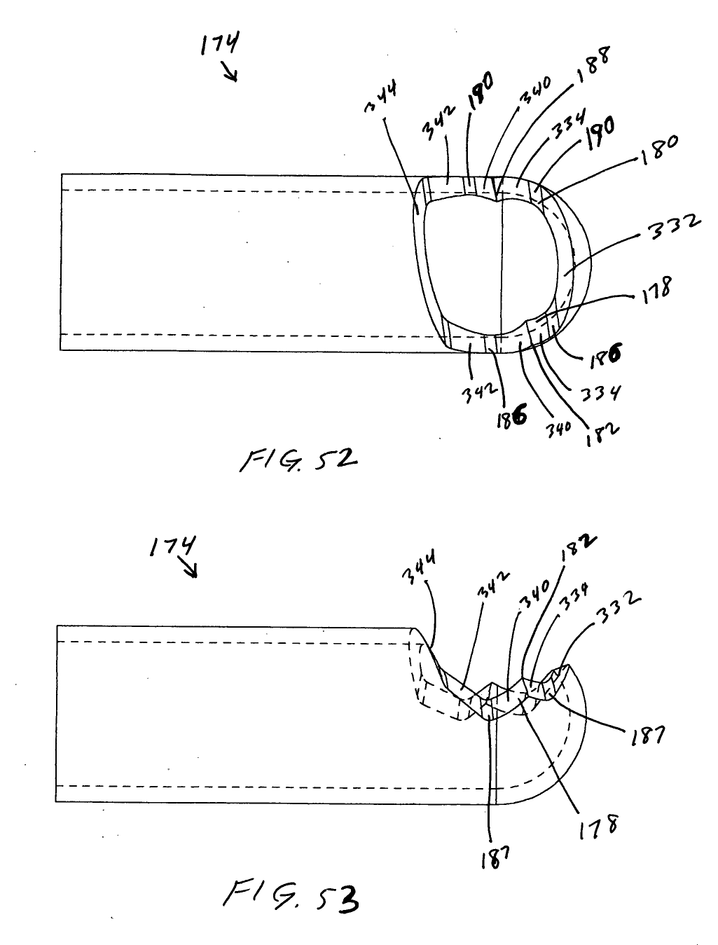

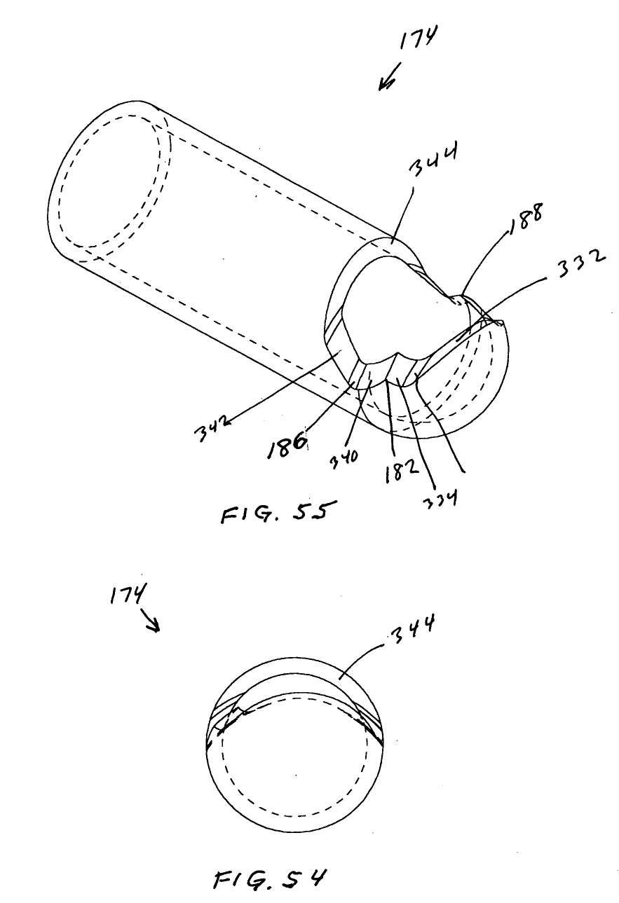

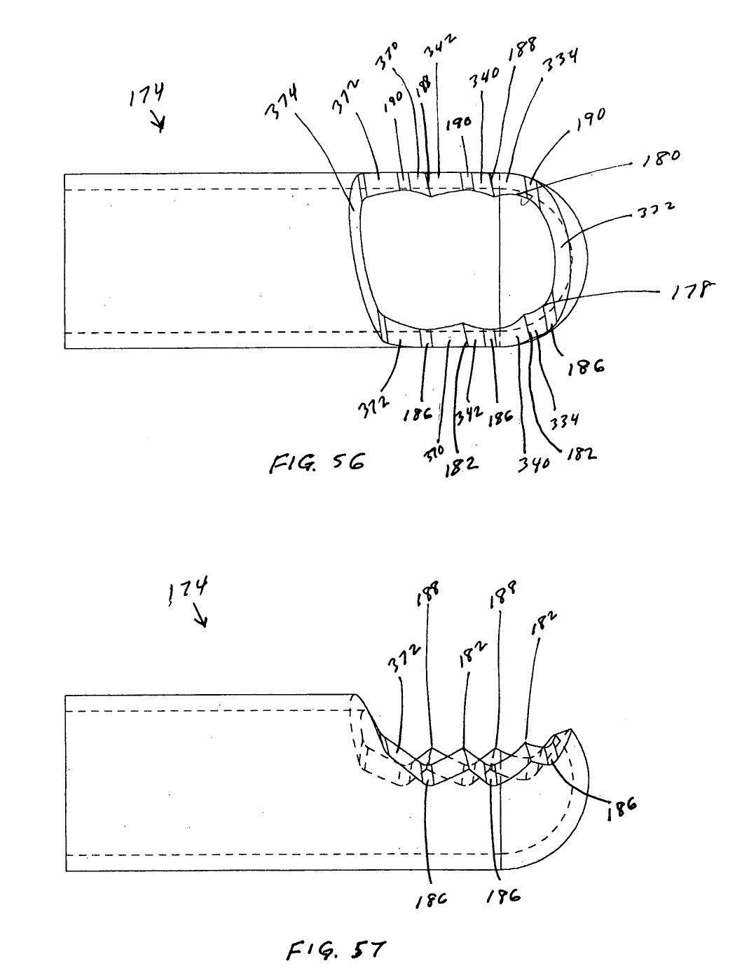

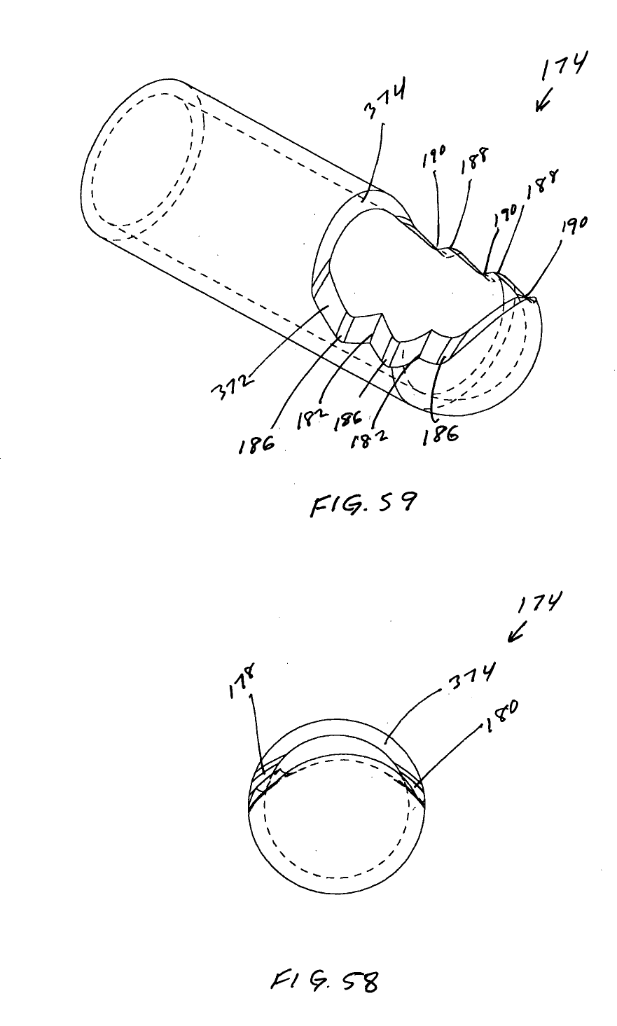

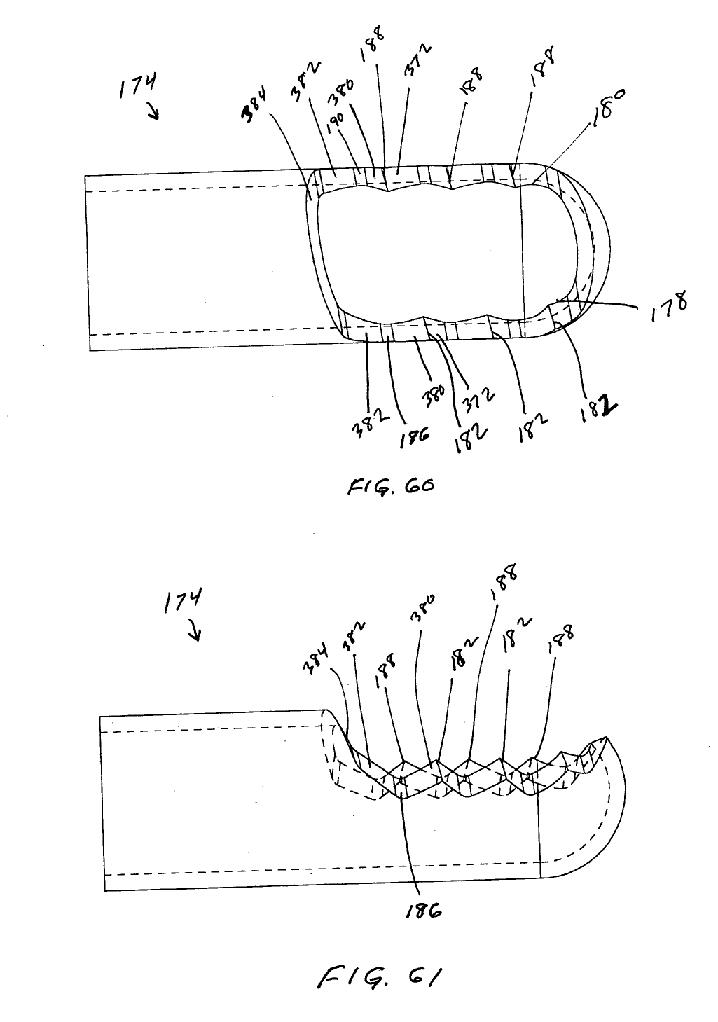

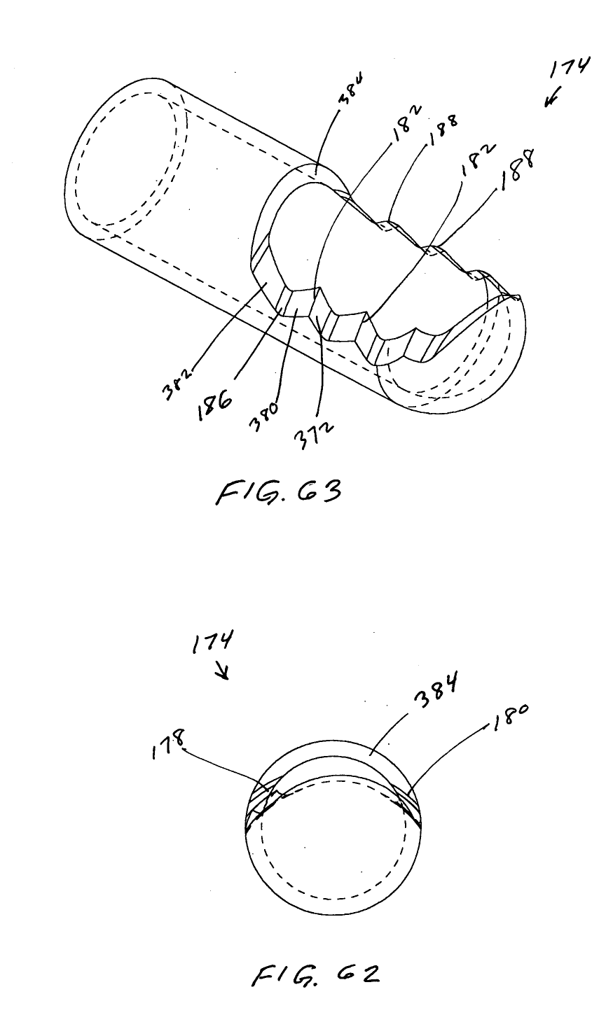

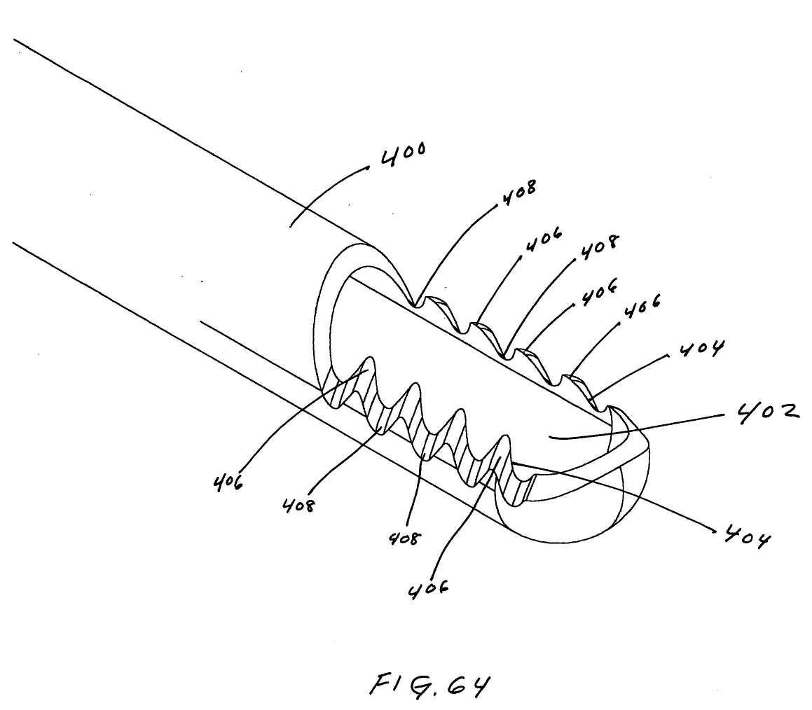

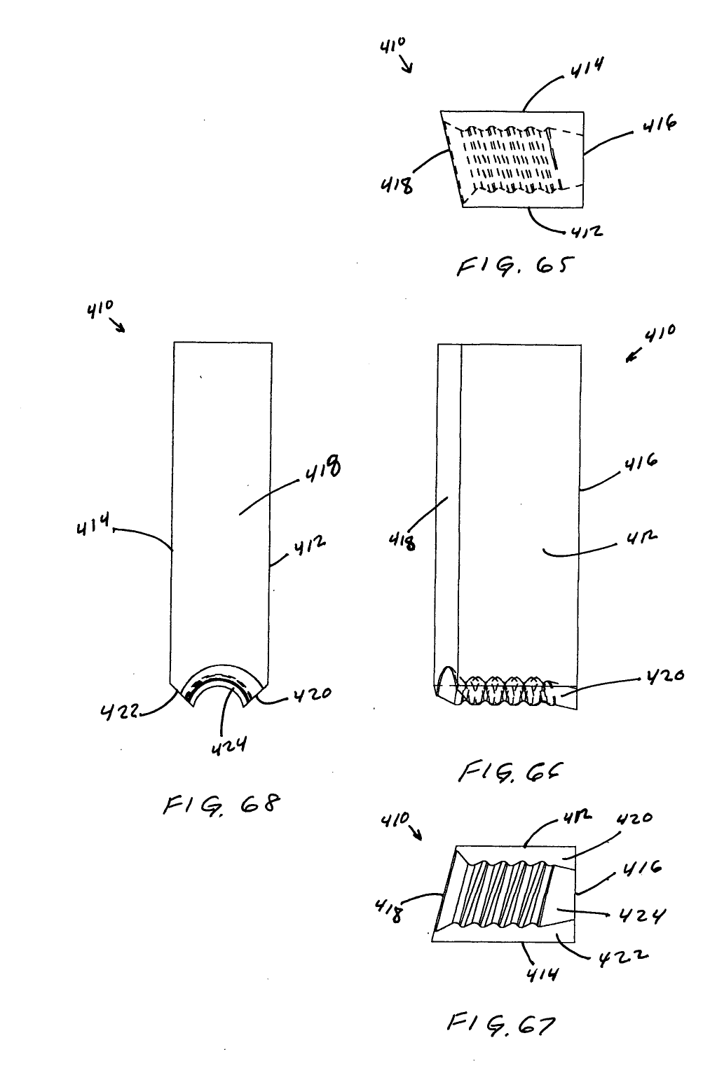

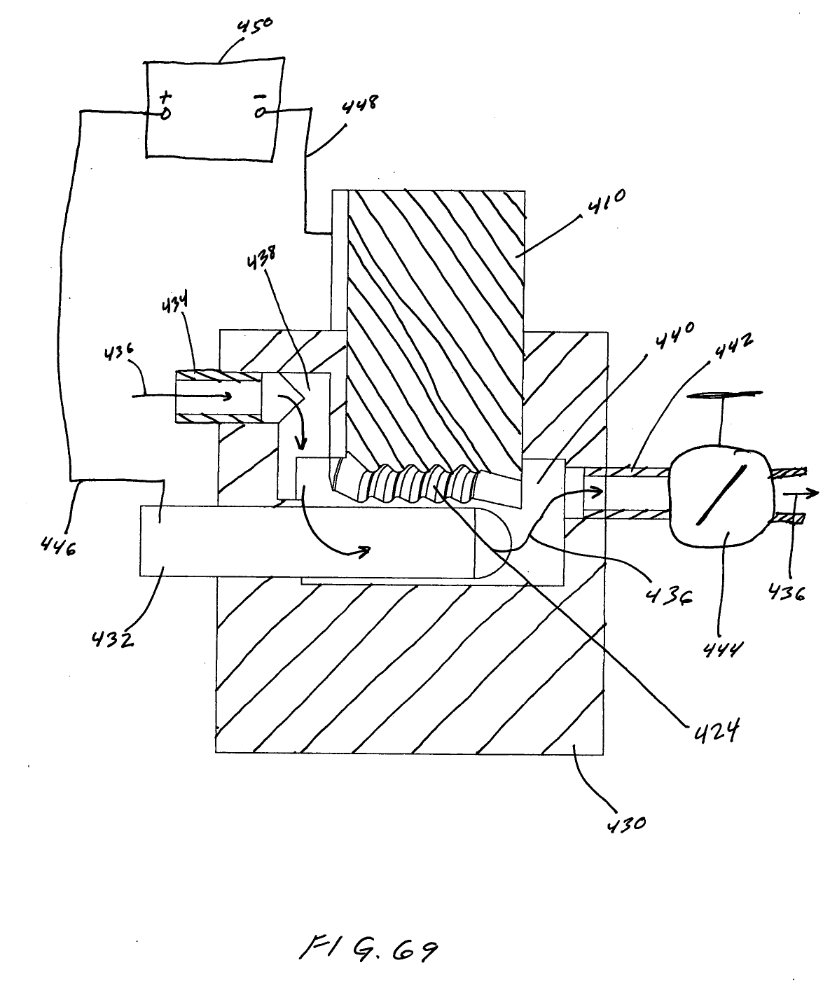

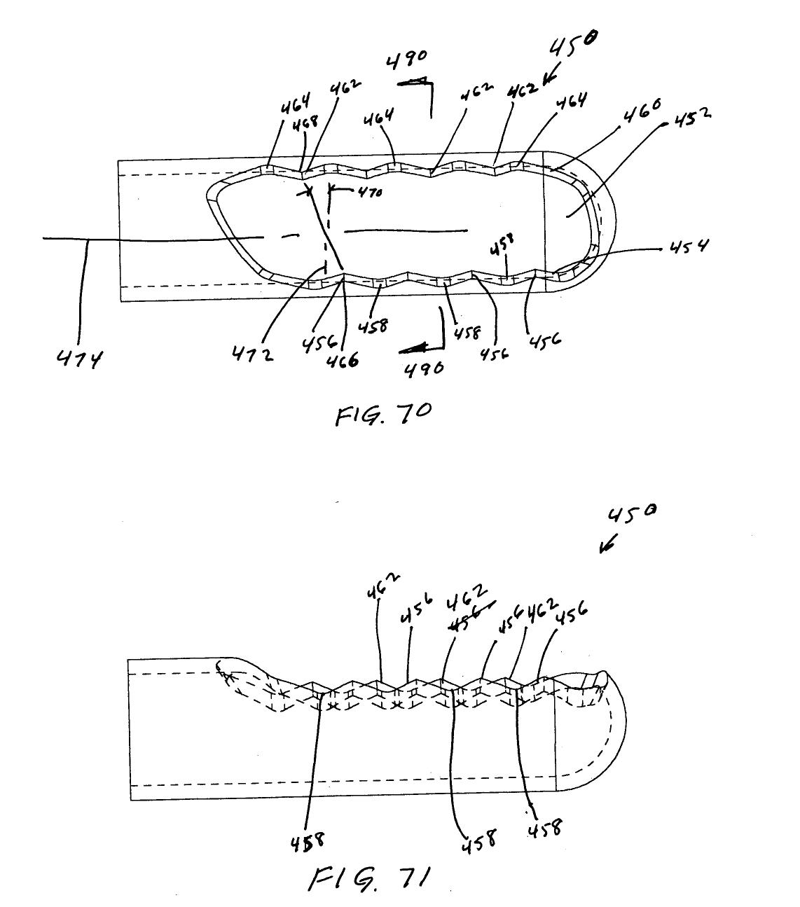

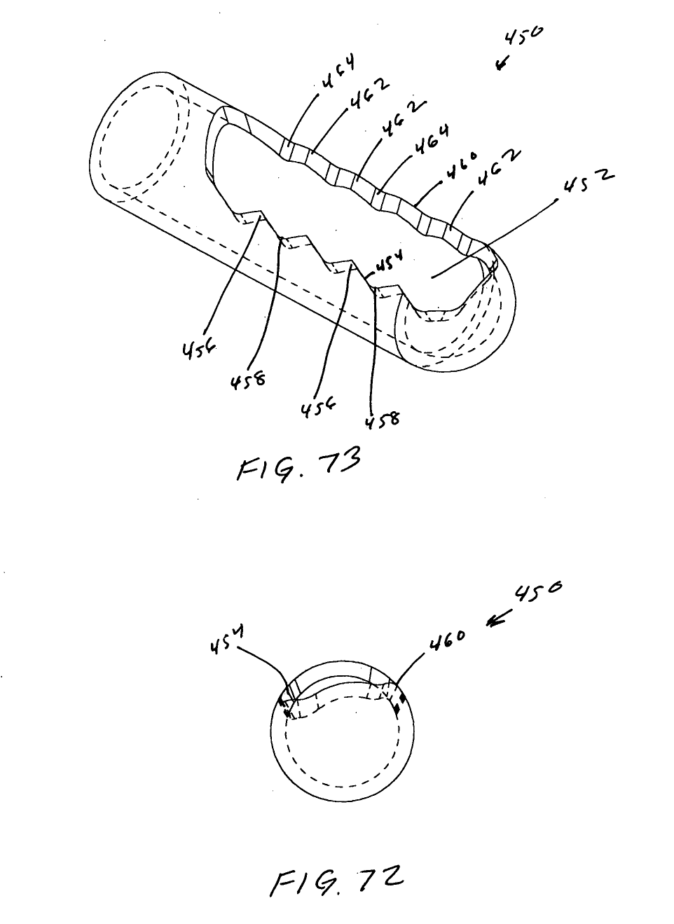

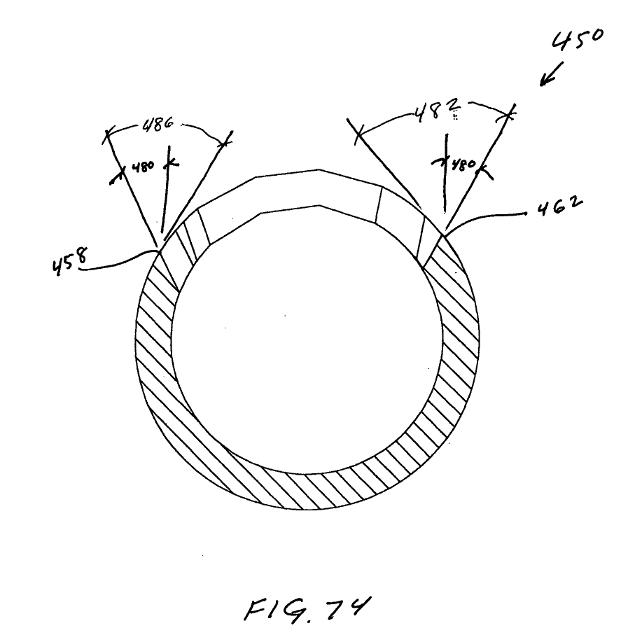

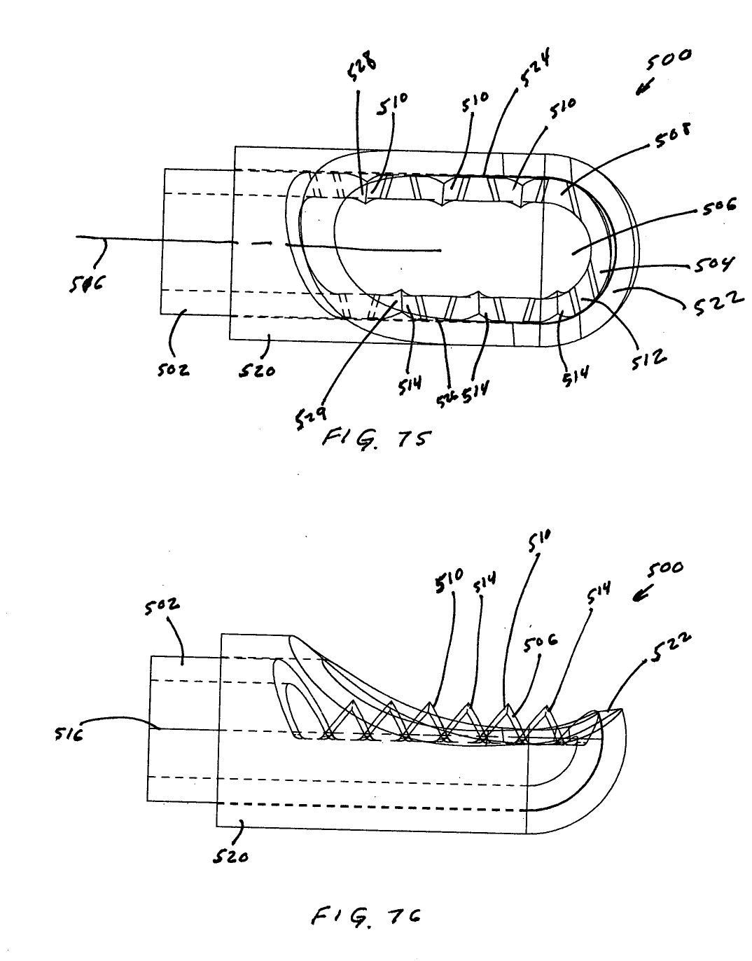

In a preferred embodiment of the invention herein disclosed, the distal end of which is shown in FIGS. 6 through 16, shaver 50 has an inner tube 52 rotatably positioned within outer tube 54. Referring to FIGS. 15 through 19, inner cutting window 56 has first lateral cutting edge 58 and second lateral cutting edge 60. Edge 58 has teeth 62 axially spaced distance 64 apart, teeth 62 being separated by valleys 66. Edge 60 has teeth 68 also spaced distance 64 apart and separated by valleys 70. As seen in FIG. 15, line 73 from the center of proximal-most tooth 72 of edge 58 to the center of proximal-most tooth 74 of edge 60 forms angle 76 with plane 78 normal to axis 79. Each tooth of edge 58 has a corresponding tooth of edge 60 from which it is offset angle 76. As best seen in FIG. 19, when viewed in direction 78 (FIG. 15) teeth 62 and 68 have a constant cross-section, two-dimensional shape which can be produced by through-cutting processes such as grinding or wire EDM. The teeth shown have tips formed of cylindrical radii 69 and valleys formed of cylindrical radii 71 connected by more or less planar surfaces. The shapes shown are for illustration only and are not meant to limit the scope of the invention. Other tooth shapes may be used as required for particular applications. For instance, radii 69 may be minimized and/or radii 71 increased to enhance the ease with which the teeth penetrate tissue.

Referring to FIGS. 10 through 14, outer tube 54 has outer cutting window 86 with lateral cutting edges 88 and 90. Edge 88 has teeth 92 axially spaced distance 94 apart, teeth 92 being separated by valleys 96. Edge 90 has teeth 98 also spaced distance 94 apart and separated by valleys 100. As seen in FIG. 10 line 103 from the center of proximal-most tooth 102 of edge 88 to the center of proximal-most tooth 104 of edge 90 forms angle 106 with plane 108 normal to axis 109. Each tooth of edge 88 has a corresponding tooth of edge 90 from which it is offset angle 106. As best seen in FIG. 14, when viewed in direction 108 (FIG. 10) teeth 92 and 98 have a constant cross-section, two-dimensional shape which can be produced by a through-cutting processes such as grinding or wire EDM. The teeth shown have tips formed of cylindrical radii 89 and valleys formed by cylindrical radii 91 connected by more or less planar surfaces. The tooth shapes shown are for illustration only and are not meant to limit the scope of the invention. Other shapes may be used as required for particular applications. For instance radii 89 may be minimized and/or radii 91 increased to enhance the ability of the teeth to penetrate tissue during use.

Referring now again to FIGS. 6 through 9, teeth 92 of edge 88 of outer window 86 are more or less aligned with teeth 62 of edge 58 of inner window 56, and teeth 98 of edge 90 of outer window 86 are more or less aligned with teeth 68 of edge 60 of inner window 56. Teeth 62 of edge 58 of inner window 56 are also more or less laterally aligned with valleys 100 of cutting edge 90 of outer window 86, and teeth 68 of edge 60 of inner window 56 are more or less laterally aligned with valleys 96 of cutting edge 88 of outer window 86. During use, when the shaver distal end is placed in contact with tissue and inner member 52 is rotated clockwise, teeth 68 of edge 60 penetrate tissue sucked into window 86 and, in cooperation with teeth 92 of outer cutting edge 98 which also penetrate the tissue, retain the tissue between the cutting edges so that it is resected as the edges meet and pass. When inner member 52 is rotated counterclockwise, teeth 62 of edge 58 penetrate tissue sucked into window 86 and, in cooperation with teeth 98 of edge 90 which also penetrate the tissue, retain the tissue between the cutting edges so that it is resected as the edges meet and pass. The region of the tissue affected by each tooth 68 of inner cutting edge 60 is displaced axially from a corresponding region affected by a tooth 62 of edge 58 half of distance 64, the distance between adjacent teeth on a given cutting edge. Because of this the ability of the inner cutting edges to penetrate tissue and retain it in the cutting window is enhanced compared to conventional inner cutting edges having teeth which are symmetrically placed about the center plane of the inner window. The valleys of the outer cutting edges are aligned with the teeth of the laterally opposed inner cutting edges for improved resection efficiency.

In certain applications, for instance when cutting tough tissue such as meniscus, it is advantageous to have fewer but larger teeth on the inner cutting edges than on the outer cutting edges. These fewer larger teeth are able to more easily penetrate tough tissue so that it can be retained in the cutting window and resected. Accordingly, in another embodiment the number of teeth on the inner and outer cutting edges is not equal. Because the inner and outer edges do not have an equal number of teeth, teeth on an inner cutting edge will not necessarily align with valleys on the corresponding opposite outer cutting edge. The alignment of teeth and valleys on cooperating inner and outer cutting edges will vary with position in the cutting window.

The surface of a cutting edge over which resected material must slide in leaving the cutting region is called the rake surface. The sharpness of a shaver is strongly affected by the ease with which tissue is able to slide over the rake surface of a shaver blade. It is desirable to decrease friction between the rake surface and tissue sliding over the surface. This may be accomplished by increasing the smoothness of the surface, and by decreasing the included angle of the cutting edge. The outer cutting edges of the prior art shaver and first embodiment of this invention both have large included angles. Referring to FIG. 20 showing an axial section view of prior art shaver 24 in a plane centered in an outer cutting edge valley 48 and inner cutting edge tooth 32 (FIGS. 2 through 4), inner cutting edge teeth 32 have included angle 106 at their tips, an efficient geometry for penetrating tissue and preventing it from being ejected from the cutting window. However, the portion of the inner cutting edge which must cooperate with the outer cutting edge in order to separate tissue is the region in which the machined surface intersects the cylindrical outer surface of the inner tube. Included angle 108 of this edge is an obtuse angle inefficient for tissue resection. Similarly, included angle 110 of outer cutting edge 42 in valleys 48 while slightly acute is undesirably large for tissue resection.

Referring to FIG. 21 showing an expanded distal end sectional view of shaver 50 constructed in accordance with the principles of this invention, inner cutting edge 58 in the region of a tooth 62 has obtuse included angle 120 while outer cutting edge 88, in the region of a tooth 92, has slightly acute included angle 122. Inner edge 60 in the region of a valley 70 has an included angle 124 and outer edge 90 also in the region of a valley has included angle 126. Angles 124 and 126 are large, approaching 90 degrees. Included angles 120, 122, 124, and 126 are undesirably large for tissue resection.

Referring to FIGS. 22 through 29 showing another embodiment of the invention disclosed herein, shaver 130 has an inner member 132 rotatably positioned within outer member 134. The distal portion of inner member 132 is similar in construction to the distal portion of inner member 52 of shaver 50 (FIGS. 15 through 19). That is, inner cutting window 136 has a first lateral cutting edge and a second lateral cutting edge, each having regularly spaced teeth separated by valleys. The teeth of the first lateral cutting edge are displaced axially from the teeth of the second lateral cutting edge. A line drawn between any tooth on the first lateral cutting edge to its corresponding tooth on the second lateral cutting edge forms a predetermined angle with the tube axis. When viewed at this given angle to the tube axis, that is, in profile, the teeth have a two-dimensional shape composed of cylindrical valley and tip radii connected by planar surfaces, although other two-dimensional shapes may be selected.

As best seen in FIGS. 26 through 29, outer tube 134 has outer cutting window 136 with lateral cutting edges 138 and 140. Edge 138 has teeth 142 axially spaced distance 144 apart, teeth 142 being separated by valleys 146. Edge 140 has teeth 148 also spaced distance 144 apart and separated by valleys 150. Teeth 142 and 148 have tips formed by fillets 149. A line from the center of proximal-most tooth 152 of edge 138 to the center of proximal-most tooth 154 of edge 140 forms angle 156 with plane 158 normal to axis 159. Each tooth 142 of edge 138 has a corresponding tooth 148 of edge 140 from which it is offset angle 156.

Referring now to FIG. 30 showing a sectional view at location 147 (FIG. 26) of shaver 130 taken through a tooth 142 of outer lateral cutting edge 138 and a valley 150 of outer cutting edge 140 of shaver 130, and also through a tooth of the first lateral cutting edge of the inner window and a valley of the second lateral cutting edge of the inner window. The sectional view of FIG. 30 corresponds in location to the axial sectional view of FIG. 21 of previous embodiment shaver 50. The included angles of the inner cutting edges of shaver 130 are similar in size to corresponding angles 120 and 124 of inner 52 of shaver 50 (FIG. 21). The included angles of the outer cutting edges are, however, quite different. Referring to FIG. 30, tooth 142 of edge 138 has included angle 160 and valley 150 of edge 140 has included angle 162. Comparing the outer cutting edge geometry of shaver 50 (FIG. 21) and shaver 134 (FIG. 30), the included angle 160 of tooth 142 of edge 138 of shaver 134 (FIG. 30) is much less than included angle 122 of tooth 92 of outer cutting edge 88 of shaver 50 (FIG. 21). Similarly, included angle 162 of the cutting edge at valley 150 of edge 140 (FIG. 30) is less than included angle 126 of the cutting edge at valley 100 of cutting edge 90 of outer tube 54 of shaver 50 (FIG. 21). The decreased included angles of the cutting edges decrease the resistance to tissue sliding over the rake surface thereby increasing shaver efficiency.

Referring to FIGS. 31 through 34 showing another embodiment of the invention disclosed herein, shaver 170 has an inner member 172 rotatably positioned within outer member 174. The distal portion of inner member 172 is similar in construction to the distal portion of inner member 52 of shaver 50 and inner member 132 of shaver 130. That is, inner cutting window 176 has a first lateral cutting edge and a second lateral cutting edge, each having regularly spaced teeth separated by valleys. The teeth of the first lateral cutting edge are displaced axially from the teeth of the second lateral cutting edge. A line drawn between any tooth on the first lateral cutting edge to its corresponding tooth on the second lateral cutting edge forms a predetermined angle with the tube axis. When viewed at this given angle to the tube axis, that is, in profile, the teeth have a two-dimensional shape composed of cylindrical valley and tip radii connected by more or less planar surfaces, although other two-dimensional shapes may be selected.

Referring to FIGS. 35 through 38, outer tube 174 has outer cutting window 176 with lateral cutting edges 178 and 180. Edge 178 has teeth 182 axially spaced distance 184 apart, teeth 182 being separated by valleys 186. Edge 180 has teeth 188 also spaced distance 184 apart and separated by valleys 190. A line 179 from the center of proximal-most tooth 192 of edge 178 to the center of proximal-most tooth 194 of edge 180 forms angle 196 with plane 198 normal to axis 199. Each tooth 182 of edge 178 has a corresponding tooth 188 of edge 180 from which it is offset angle 196. As with outer tube 134 of shaver 130 (FIGS. 26 through 29), edge 178 and edge 180 have throughout their length a low included angle formed by rake surfaces 200 and 202.

Referring now to FIG. 39 showing a sectional view of shaver 170 taken at location 179 (FIG. 35) through tooth 182 of outer lateral cutting edge 178 and valley 190 of outer cutting edge 180 of shaver 170, and also through a tooth of the first lateral cutting edge of the inner window and a valley of the second lateral cutting edge of the inner window. The upper crest of teeth 182 form radius 210. The lower surface of valleys 190 form radius 212, radii 210 and 212 being concentric. The center of radii 210 and 212 is displaced below axis 214 of outer tube 174 distance 216. The intersections of rake surfaces 200 and 202 with the inner lumen of outer tube 174 create low included angle cutting edges throughout the outer window.

Cutting window 176 of outer tube 174 is formed by a series of grinding operations. A grinding wheel having a shaped periphery is moved to a first position relative to outer tube 174, the axis of the grinding wheel being offset angularly from the axis of tube 174. With the grinding wheel rotating, the wheel is moved relative to tube 174 along a helical path formed by complex simultaneous motion of the grinding wheel and tube to a second position relative to tube 174 so as to grind a portion of the cutting window. The tube is repositioned and the grinding operation repeated so as to form another portion of the cutting window. The process is repeated until the entire window is formed.

As seen in FIGS. 40 through 42, grinding wheel 300 has an axis 301 and a periphery 302 formed or a plurality of angled surfaces. As best seen in FIG. 42, surface 304 of periphery 302 has a conical angle 306; surface 308 has a conical angle 310; and surface 312 has a conical angle 314. The axes of surfaces 304, 308 and 312 are coaxial with axis 301 of wheel 300. Surfaces 304 and 308 are joined by fillet 313.

Referring now to FIGS. 43 through 47 showing grinding wheel 300 positioned for the first grinding operation to form window 176 of tube 174 (FIGS. 35 through 38), as best seen in FIG. 43 axis 301 of wheel 300 is offset from axis 303 of tube 174 by angle 316. Angle 316 is approximately equal to angle 196 (FIG. 35). While wheel 300 rotates, it is moved along a helical path relative to tube 174 to a second position such that wheel periphery 302 intersects a distal portion of tube 174 thereby creating a helical opening in the distal end of tube 174. The axis of the helical relative motion and the axis of the tube are not concentric.

The helical relative motion between tube 174 and grinding wheel 300 are most readily accomplished on a computer numerically controlled (CNC) multi-axis grinding machine (commonly called a “burr grinder”), although other machines and methods may be used. A preferred CNC multi-axis grinding machine is the GrindSmart 620XS™ by Rollomatic USA (Mundelein, Ill.). Other suitable multi-axis CNC grinders are available from a variety of manufacturers.

Referring to FIGS. 48 through 51, ground opening 330 of tube 174 formed by the first grinding operation has a helical form, the axis of which is offset distance 331 from the axis of tube 174 (FIG. 51), distance 331 being equal to distance 216 of FIG. 39. Opening 330 has surface 332 formed by surface 304 of wheel 300 (see FIG. 47), surfaces 334 formed by surface 308 of wheel 300, and surface 336 formed by surface 312 of wheel 300. Radius 313 of wheel 300 forms a valley 186 of edge 178, and a valley 190 of edge 180 (FIGS. 35 through 38).

FIGS. 52 through 55 show tube 174 after the second grinding operation which is identical to the first operation except that tube 174 has been repositioned distally a distance equal to distance 184 (FIG. 35), the axial distance between adjacent teeth on a cutting edge, after the first grinding operation. In the second grinding operation surfaces 340 are formed by surface 304 of wheel 300 (FIG. 42), surfaces 342 are formed by surface 308 of wheel 300, and surface 344 is formed by surface 312 of wheel 300. Radius 313 of wheel 300 forms another valley 186 of edge 178 and another valley 190 of edge 180 (FIGS. 35 through 38) the newly formed valleys being proximal to those formed in the first grinding operation. Surfaces 334 and 340 together form a tooth 182 of edge 178 and tooth 188 of edge 180.

FIGS. 56 through 59 show tube 174 after the third grinding operation which is identical to the first and second operations except that tube 174 has been advanced distally a distance equal to distance 184 (FIG. 35), the axial distance between adjacent teeth on a cutting edge. In the third grinding operation surfaces 370 are formed by surface 304 of wheel 300 (FIG. 42), surfaces 372 are formed by surface 308 of wheel 300, and surface 374 is formed by surface 312 of wheel 300. Radius 313 of wheel 300 forms another valley 186 of edge 178 and another valley 190 of edge 180 (FIGS. 35 through 38) the newly formed valleys being proximal to those formed in the first and second grinding operations. Surfaces 342 and 370 together form a tooth 182 of edge 178 and tooth 188 of edge 180.

FIGS. 60 through 63 show tube 174 after the fourth grinding operation which is identical to the previous operations except that tube 174 has been advanced distally a distance equal to distance 184 (FIG. 35), the axial distance between adjacent teeth on a cutting edge, after the third grinding operation. In the fourth grinding operation surfaces 380 are formed by surface 304 of wheel 300 (FIG. 42), surfaces 382 are formed by surface 308 of wheel 300, and surface 384 is formed by surface 312 of wheel 300. Radius 313 of wheel 300 forms another valley 186 of edge 178 and another valley 190 of edge 180 (FIGS. 35 through 38) the newly formed valleys being proximal to those formed in the first and second grinding operations. Surfaces 380 and 372 together form a tooth 182 of edge 178 and tooth 188 of edge 180.

A fifth grinding operation, performed in the same manner as the four previously herein described, completes the forming of window 176 of outer tube 174 as shown in FIGS. 35 through 38. The edges so formed have low included angles throughout. The teeth have sharp points rather than radii. The troughs between teeth have an oblique surface which decreases the included angle of the cutting edges in these regions.

The method for forming window 176 in outer tube 174 herein described utilizes multiple grinding operations each producing a helical contour forming a portion of window 176. The center of the helix is offset from the axis of outer tube 174. The distance between the tube axis and helix axis can be increased or decreased so as to increase or decrease the included angle of the cutting edges to achieve specific edge characteristics. For instance, the included angle of the cutting edge can be increased to make the edge less susceptible to damage, or decreased to increase shaver aggressiveness when cutting tissue.

The form of the teeth of the outer cutting window is determined by the form of the periphery of the grinding wheel. In the embodiment produced by grinding herein described, the periphery of the wheel is formed of conical surfaces. Other forms may be used to achieve more aggressive tissue resection or to make the teeth more resistant to deformation and damage when removing tissue from bony surfaces. For instance, the periphery of the wheel can be formed with convex arcuate surfaces so that the valleys between teeth are increased in size and the teeth are narrowed so as to improve the penetration of the teeth into tissue. Alternatively, a wheel periphery having conical surfaces with low included angles will produce less pronounced teeth having a strong form resistant to deformation and damage.

In the ground embodiment herein disclosed the axial tooth spacing is constant and the axis of the helical cutting edge is displaced a constant distance from the tube axis. Other embodiments are anticipated in which the tooth spacing is not constant. Also, other embodiments are anticipated in which the distance between the tube axis and the helix axis of the grinding operations is not constant but is varied from grinding operation to grinding operation to achieve advanced window geometries. For instance, the window opening may be small at its distal end and increase in size in its more proximal regions so as to function primarily as a side-cutting shaver, or have a window with a large distal portion and smaller proximal region so as to function primarily as an end-cutting shaver.

The multi-step grinding method for producing an outer window is unable to make outer window cutting edges like those shown in FIGS. 26 through 30 due to the radii on the tips of the teeth. Such cutting edges may be made by Electrical Discharge Machining (EDM) using an electrode which is shaped as the complement of the desired final cutting edge shape. EDM is, however, poorly suited to the manufacture of cutting edges as it produces rough surface finishes, and has high associated costs since the electrode is consumed during use.

Referring to FIG. 64, the distal end of an outer shaver tube 400 has a cutting window 402 formed using an advanced electrochemical process. Cutting window 402 has cutting edges 404 with teeth 406 separated by valleys 408. Referring to FIGS. 65 through 68, cathode 410 has insulated surfaces 412, 414, 416, 418, 420, and 422. Bottom surface 424 is formed to a complement of the contours of cutting window 402, such that when properly aligned and positioned adjacent to window 402 a small, more or less uniform, gap exists between contoured surface 424 and teeth 406 and valleys 408. Cathode 410 is made from a suitable metallic material such as copper, copper-tungsten, silver-tungsten or other metallic material which has both low electrical resistivity and high resistance to damage by electrical arcs.

Referring now to FIG. 69, fixture 430, shown in section view, has a vertical opening closely conforming to cathode 410 such that cathode 410 can be vertically movably positioned therein as shown. Fixture 430 has an opening slightly larger than the outer diameter of outer tube 432 such that shaver outer tube 432 can be removably positioned therein as shown. Tube 434 supplies electrolyte 436 to passage 438 so as to fill cavity 440 with electrolyte. Electrolyte 436 exits through tube 442. Electrolyte 440 contains sodium-chloride, sodium-nitrate, sodium-nitrite, or other suitable compounds either singly or in combination. The discharge of electrolyte 440 through tube 442 is restricted by valve 444. Shaver outer tube 432 is electrically connected via a connection means 446 to the positive side of power supply 450; cathode 410 is connected via a connection means 448 to the negative side of power supply 450. Fixture 430 and cathode 410 are mounted in a machine tool (not shown) having a control system able to precisely advance cathode 410 relative to fixture 430 and shaver outer tube 432 mounted therein, and to control the output of power supply 450.

Electrochemical machining (ECM) is an electrolytic method of material removal in which a shaped cathode and a partpiece connected to a voltage source are submerged in an electrolyte. Electrolyte flows through the gap between the cathode and partpiece. When voltage is applied between the cathode and the partpiece, metal is removed electrolytically from the partpiece, the rate of metal removal at a given location being proportional to the current density at that location, which is inversely proportional to the distance between the cathode and the partpiece. Two common types of ECM are static ECM in which the cathode is held a constant distance from the partpiece during machining, and dynamic ECM in which the cathode is advanced into the partpiece at a constant rate. Static-ECM is used for removing burrs produced by prior machining operations, and for producing shallow recesses. Dynamic ECM is used to produce complex contours on products made from difficult to machine alloys, particularly in the aerospace industry.

When material is removed electrochemically, hydrogen and hydroxide solids are produced in the gap between the part piece and the cathode also frequently referred to as the “machining gap”. Flow of electrolyte through this gap carries away these products. Machining conditions within the gap are, therefore, nonuniform. Near the inflow the gap is filled with clean electrolyte. The electrolyte becomes increasingly polluted with hydrogen bubbles and hydroxide solids as it flows through the gap to the fluid exit. Liquid electrolyte participates in the machining process and electrolitically removes material, however, hydrogen bubbles in the stream do not. Accordingly, downstream regions in which hydrogen bubbles collect may have lower metal removal rates than upstream regions in which bubbles are not present or are only a small portion of the electrolyte flow. This may, in turn, result in unmachined localized projections from the partpiece which may, in the case of dynamic ECM, contact the advancing cathode causing arcing and damage to the partpiece and cathode. In dynamic ECM the size of the gap between the cathode and partpiece is strongly affected by the feedrate of the cathode into the partpiece. Large gaps lessen the chance of arcing. Feedrates are generally reduced in production ECM applications from their optimum to increase the machining gap so as to decrease arcing instances. Large gaps, however, lessen the accuracy and detail which can be produced on a partpiece. Accordingly, dynamic ECM is generally used on products that are made from difficult to machine materials and to produce features which do not require extreme accuracy.

An alternate approach to controlling hydrogen bubbles is through increasing pressure in the machining gap. The size of a hydrogen bubble is determined by the pressure exerted on it by the fluid with which it is surrounded. Increasing the pressure of the fluid decreases the size of the bubbles thereby decreasing their effect on the machining process.

The electrochemical machining process herein disclosed for producing shaver cutting edges uses advanced techniques to control hydrogen within the machining gap so as to allow the reduction of the gap size and increase of part accuracy and edge quality. Referring again to FIG. 69, during use outer tube 432 is mounted in fixture 430. Cathode 410 is advanced until surface 424 is in close proximity to tube 432. Electrolyte 436 is continually pumped into tube 434 filling volume 440 and flowing from outflow tube 442. Outflow of electrolyte 436 is restricted by valve 444 so that the desired pressure is achieved in volume 440. Power supply 450 is activated for a predetermined period of time, generally in the range from 0.2 to 0.5 seconds during which voltage is applied between tube 432 and cathode 410. During this period material is removed from tube 432 by electrolytic action, the greatest removal occurring in regions in which surface 424 is in closest proximity to tube 432. After the period during which voltage is applied, a predetermined idle time occurs during which hydrogen and hydroxides are flush from the machining gap. The idle time is generally less than one second. Following the idle time, cathode 410 is advanced a precise, predetermined distance so as to decrease the size of the gap between cathode 410 and tube 432. Power supply 450 is then activated for a predetermined period as previously, followed by an idle time and the advance of cathode 410. This cycle continues until cathode 410 is advanced a predetermined total distance, whereupon cathode 410 is retracted and tube 432 with completed cutting edges 404 is removed from the fixture.

The construction of fixture 430 differs from those generally used for electrochemical machining. ECM fixtures are generally constructed so that all electrolyte flow passes through the machining gap. This results in large pressure drops along the gap causing hydrogen bubbles in the gap to increase in size. In contrast, the construction of cavity 440 of fixture 430 allows a large portion of the electrolyte flow to bypass the machining gap thereby equalizing the pressure within the cavity. The presence of pressurized electrolyte in cavity 440 decreases the pressure drop across the gap and minimizes the volume of hydrogen bubbles within the gap. This allows machining to be performed with smaller gaps than if standard ECM fixturing methods with little or no bypass flow were used.

Additionally, the machining cycle, that is the sequence of predetermined periods of voltage application and idle time following which the cathode is advanced toward the part piece, further improves the ability of the process to produce precise cutting edges. At the first instance that voltage is applied to a machining gap filled with electrolyte, the entire gap is filled with electrolyte free of hydrogen and hydroxides. Material rates are maximal. As metal removal continues electrolyte in the gap becomes polluted as previously described. By applying voltage for brief periods for metal removal followed by idle periods during which electrolyte flow removes hydrogen and hydroxides from the gap as in the cycle described, the gap between cathode 410 and tube 432 can be decreased and improved part quality achieved.

The cutting edges of the inner cutting windows of embodiments previously herein disclosed have had cutting edges with large included angles. It is also possible to produce asymmetric inner cutting windows with edges which have low included angles. In an embodiment shown in FIGS. 70 through 74 inner tube 450 with cutting window 452 has a first cutting edge 454 with teeth 456 separated by valleys 458, and a second cutting edge 460 with teeth 462 separated by valleys 464. A line from the center of proximal-most tooth 466 of edge 454 to the center of proximal-most tooth 468 of edge 460 forms angle 470 with plane 472 normal to axis 474. Each tooth of edge 454 has a corresponding tooth of edge 460 from which it is offset angle 470. FIG. 74 shows a section taken at location 490 (FIG. 70) through a tooth 462 of edge 460 and in the region of a valley 458 of edge 454. Window 452 decreases in width by angle 480 imparted by the manufacturing process used to create cutting edges 454 and 460. Tooth 462 of cutting edge 460 has included angle 482 and valley 458 of cutting edge 484 has included angle 486, both included angles being significantly less than the included angles at corresponding locations of inner member 52 of shaver 50 (FIGS. 15 through 20). Included angles 482 and 484 can be further decreased by decreasing angle 480. Angle 480 is generally in the range of 0 to 45 degrees, and more preferably in the range of 0 to 30 degrees.

Inner member 450 can be used in the outer members of the previous embodiments, or may be used in an outer member having cutting edges which do not have teeth.

Inner member 450 may be produced by EDM or conventional machining, however, the preferred method is the advanced electrochemical process previously herein described.

It is not always desirable to have outer cutting edges with teeth. When cleaning tissue from bony surfaces, or when resecting bone, the teeth of the outer cutting edge may be deformed by impact with the bone. Some surgeons also prefer an outer window without teeth since teeth on the outer cutting edges may cause inadvertent damage to articulator surfaces when the shaver is inserted into the joint space. An outer window with asymmetrical cutting edges will have increased resection efficiency compared to a conventional window due to the different “scissoring” action of each edge when the shaver is used in oscillate mode. Also, the window geometry can be optimized for use with an asymmetric inner cutting window. That is, the outer window shape can be made to more or less conform in shape to the inner cutting window.

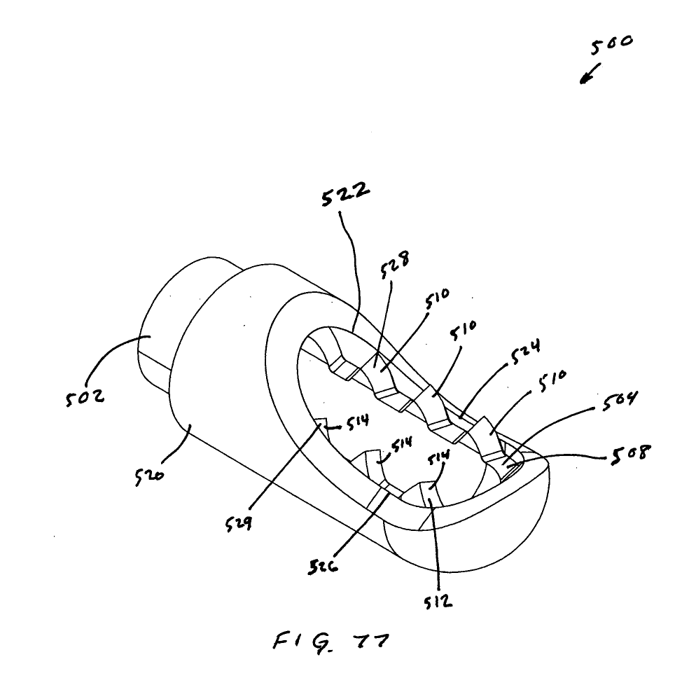

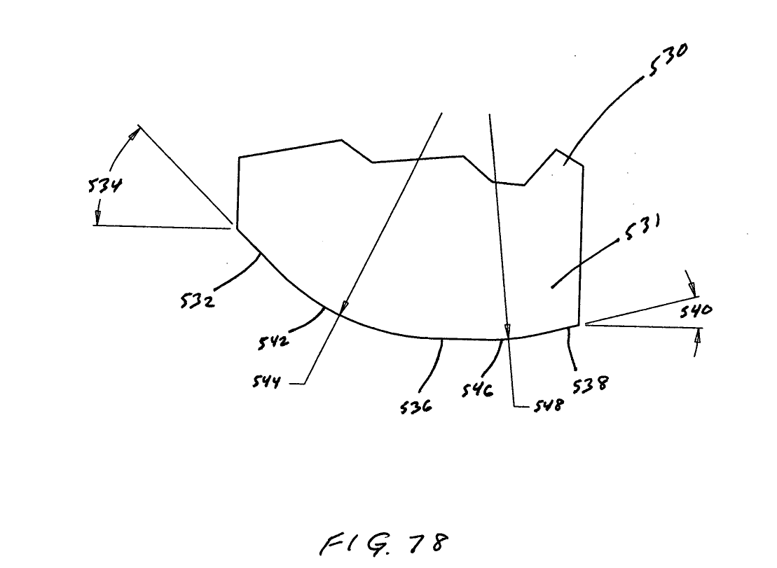

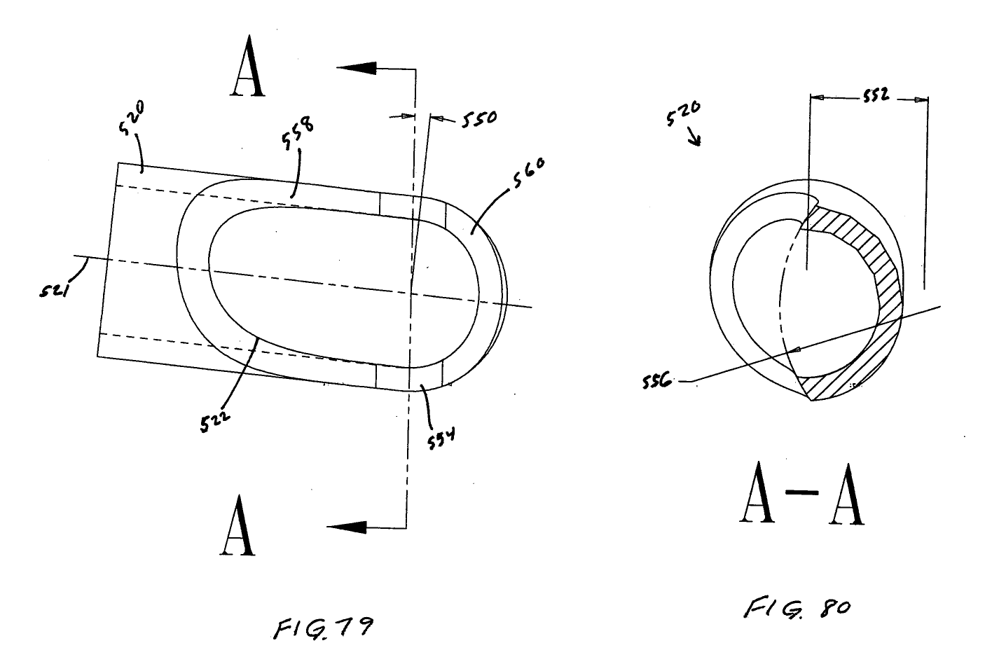

An embodiment having an asymmetrical outer cutting window without teeth is shown in FIGS. 75 through 77. Shaver 500 has an inner tube assembly 502 with a distal end 504 rotatably positioned within outer member 520. Inner cutting window 506 has a first cutting edge 508 with teeth 510 and a second cutting edge 512 with teeth 514. Teeth 510 and 514 are asymmetrically placed about center plane 516. Outer window 522 of outer member 520 has a first curvilinear cutting edge 524 and a second curvilinear cutting edge 526. First edge 524 extends proximally sufficient distance to expose proximal-most tooth 528 of first inner cutting edge 508. Second cutting edge extends proximally sufficient distance to expose proximal most tooth 529 of second inner cutting edge 512. FIG. 78 shows the profile of the perimetral edge 531 of the grinding wheel 530 used to form outer window 522 of outer member 520. Edge 530 has a first conical surface 532 forming an angle 534 with the axis of wheel 530, a cylindrical portion 536, and a second conical surface 538 forming an angle 540 with the axis of wheel 530. Fillet 542 of radius 544 is tangent to first conical surface 532 and cylindrical portion 536; fillet 546 of radius 548 is tangent to cylindrical portion 536 and second conical surface 538.

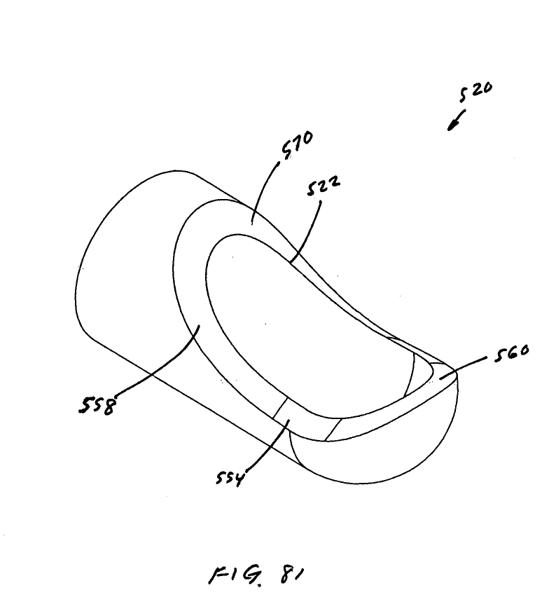

Referring now to FIGS. 79 and 80, outer window 522 is formed by positioning grinding wheel 530 at a first position with its axis offset angle 550 from the tube axis and then moving it along a helical path to a second position, the helix angle being equal to angle 550 and the axis of the helix being displaced distance 552 from the axis 521 of outer tube 520. Cylindrical surface 536 of wheel perimetral edge 531 forms cylindrical portion 554 of window 522, portion 554 having a radius 556. First conical surface 532 and fillet 542 of edge 531 form proximal portion 558 of window 522. Second conical surface 538 and fillet 548 of edge 531 form distal portion 560 of window 522. As best seen in FIG. 81, outer window 522 is surrounded by an oblique surface 570 which decreases the included angle of the cutting edge, in effect, “sharpening” the edge.

Shaver 500 is used in the same manner as the previous embodiments. The shaver will not be as aggressive when cutting soft tissue as previous embodiments which have teeth on both the inner and outer cutting edges, but will be more resistant to damage when cleaning bony surfaces.

1. A surgical powered shaver blade assembly comprising:
an elongated outer tubular member having an axis, a distal end, a proximal end and an opening at said distal end, said opening being formed so that when viewed in any section normal to the tube axis said section of said tube is asymmetric about any line;
an elongated inner tubular member co-axially aligned and adapted to move within said outer tubular member and having a cylindrical body with a distal end and a proximal end; and
a cutting means at said distal end of said inner tubular member for cutting tissue presented through said opening.

2. The assembly of claim 1 wherein said distal end further comprises an oblique surface surrounding said opening, said oblique surface forming when viewed in an axial sectional view therethrough, an acute angle with the inner surface of said outer tubular member at the perimeter of said opening, and an obtuse angle with the outer surface of said outer tubular member.

3. The assembly of claim 1 wherein said opening in said outer tubular member further comprises a plurality of teeth.

4. The assembly of claim 2 wherein said opening in said outer tubular member further comprises a plurality of teeth.

5. The assembly of claim 1 wherein said cutting means of said inner tubular member comprises an opening.

6. The assembly of claim 5 wherein said opening is formed so that when viewed in any section normal to the tube axis said section of said tube is asymmetric about any line.

7. The assembly of claim 6 wherein said opening in said inner tubular member comprises a plurality of teeth.

8. A surgical powered shaver blade assembly comprising:
an elongated outer tubular member having an axis, a distal end, a proximal end and an opening at said distal end;
an elongated inner tubular member co-axially aligned and adapted to move within said outer tubular member, and having a cylindrical body with a distal end and a proximal end;
an opening in said elongated inner tubular member for cutting tissue presented through said opening in said outer tubular member, said opening in said inner tubular member being formed so that when viewed in any section normal to the tube axis said section of said tube is asymmetric about any line;

9. The assembly of claim 8 wherein said opening in said inner tubular member comprises a plurality of teeth.

10. A cutting window with a sharpened periphery for the outer tubular member of a powered surgical shaver comprising:
an opening in the closed distal end of an elongated tubular member having an axis, the perimeter of said opening being the locus of points at the intersection of the tubular member inner surface, and a helical surface having a predetermined profile, the axis of said helical surface being offset from said axis of said tubular member, such that when viewed in a plane normal to said axis of said tubular member said helical surface forms an acute angle with the inner surface of said tubular member, and an obtuse angle with the outer surface of said tubular member.

11. The cutting window of claim 10 wherein said cutting window comprises a plurality of teeth.

12. A cutting window for a tubular member of a powered surgical shaver comprising:
An opening in the closed distal end of an elongated tubular member having an axis, the perimeter of said opening being the locus of points at the intersection of the tubular member inner surface, and a surface having a predetermined profile which is constant when viewed in a direction not perpendicular to the axis of said tubular member.

13. The cutting window of claim 12 wherein said cutting window comprises a plurality of teeth.

14. A method of forming at least one opening in a predetermined portion of an outer tubular member of a surgical shaver, said predetermined portion having an axis, said method comprising the steps of:
(a) providing a hollow tubular member having an axis, a distal end and a proximal end;
(b) providing a grinding wheel having an axis and a perimetral surface provided with a predetermined profile;
(c) orienting said axis of said predetermined portion of said tubular member in a predetermined first position relative to said grinding wheel;
(d) rotating said grinding wheel about its axis;
(e) moving said tubular member and said grinding wheel relative to each other in a motion having both an axial and circumferential component relative to said tube so as to form an opening in said predetermined portion of said tubular member.

15. The method of claim 13 wherein said relative motion is helical.

16. A method of forming at least one opening in a predetermined portion of a tubular member of a surgical shaver, said predetermined portion having an axis, said method comprising the steps of:
a) providing a hollow tubular member having an axis, a distal end and a proximal end;
(b) providing a grinding wheel having an axis and a perimetral surface provided with a predetermined profile;
(c) orienting said axis of said predetermined portion of said tubular member in a predetermined first position relative to said grinding wheel;
(d) rotating said grinding wheel about its axis;
(e) moving said tubular member and said grinding wheel relative to each other in a motion having both an axial and circumferential component relative to said tube so as to form a portion of said opening in said predetermined portion of said tubular member;
(f) moving said tubular member a predetermined distance longitudinally along its axis; and
(g) repeating step (e).

17. The method of claim 16 wherein said relative motion is helical.

22. The method of claim 21 wherein said duration is in the range from 0.2 to 2 seconds.

23. The method of claim 20 wherein said pulses are separated by idle times in which no voltage is applied.

24. The method of claim 19 wherein said advancing is not continuous, but rather a series of incremental advances.

25. The method of claim 20 wherein said advancing is not continuous, but rather a series of incremental advances.
